(19) United States
(12) Patent Application Publication
(10) Pub. No.: US 2015/0341183 A1
(43) Pub. Date: Nov. 26, 2015

(54) FORWARDING MULTICAST DATA PACKETS

(71) Applicant: HANGZHOU H3C TECHNOLOGIES CO., LTD., Hangzhou, Zhejiang (CN)

(72) Inventors: Yubing SONG, Beijing (CN); Xiaopeng YANG, Beijing (CN)

(21) Appl. No.: 14/648,854

(22) PCT Filed: Dec. 11, 2013
(86) PCT No.: PCT/CN2013/089042

§ 371 Date: Jun. 1, 2015

(30) Foreign Application Priority Data
Dec. 11, 2012 (CN) 201210539572.8

(51) Int. Cl. H04L 12/18; H04L 29/12; H04L 12/46

(52) U.S. Cl. CPC H04L 12/1886; H04L 12/4645; H04L 12/185; H04L 61/2069

(57) ABSTRACT

According to an example, a method for forwarding multicast data packets includes receiving a first multicast data packet having a first multicast address, in which the first multicast address belongs to a first multicast group having a multicast source inside of a data center and sending the first multicast data packet through a designated router (DR) router port and a gateway router port, in which the DR router port and the gateway router port correspond to a virtual local area network identifier (VLAN ID) identified in the first multicast data packet.

### BACKGROUND

Very large layer 2 (VLL2) networking technology has been implemented in data center (DC) networks. VLL2 networking technologies such as the transparent interconnection of lots of links (TRILL) and the shortest path bridging (SPB) have been developed and have been standardized by different standards organizations. TRILL is a standard developed by the Internet Engineering Task Force (IETF), and SPB is a standard developed by the Institute of Electrical and Electronics Engineers (IEEE).

### BRIEF DESCRIPTION OF THE DRAWINGS

Features of the present disclosure are illustrated by way of example and not limited in the following figure(s), in which like numerals indicate like elements, in which:

FIG. 1 is a schematic diagram illustrating a network structure, according to an example of the present disclosure.

FIGS. 2A and 2B are schematic diagrams respectively illustrating a TRILL multicast tree in a data center as shown in FIG. 1, according to an example of the present disclosure.

FIGS. 3A and 3B are schematic diagrams respectively illustrating another TRILL multicast tree in a data center as shown in FIG. 1, according to an example of the present disclosure.

FIG. 4 is a schematic diagram illustrating a process of sending a protocol independent multicast (PIM) register packet to an external rendezvous point (RP) router, according to an example of the present disclosure.

FIG. 5 is a schematic diagram illustrating a process of sending a multicast data packet of an internal multicast source to an external RP router and an internal multicast group receiving end, according to an example of the present disclosure.

FIGS. 6A and 6B are schematic diagrams respectively illustrating a process of sending a multicast data packet of an external multicast source to an internal multicast group receiving end, according to an example of the present disclosure.

FIGS. 7A and 7B are schematic diagrams respectively illustrating a TRILL multicast pruned tree in a data center as shown in FIG. 1, according to an example of the present disclosure.

FIG. 8 is a schematic diagram illustrating a TRILL multicast tree in a data center as shown in FIG. 1, according to an example of the present disclosure.

FIG. 9 is a schematic diagram illustrating a process of sending, based on the TRILL multicast tree as shown in FIG. 8, a multicast data packet of an internal multicast source to an external RP router and an internal multicast group receiving end, according to an example of the present disclosure.

FIG. 10 is a schematic diagram illustrating a process of sending, based on the TRILL multicast tree as shown in FIG. 8, a multicast data packet of an external multicast source to an internal multicast group receiving end, according to an example of the present disclosure.

FIG. 11 is a schematic diagram illustrating the structure of a network apparatus, according to an example of the present disclosure.

FIG. 12 is a schematic diagram illustrating a network apparatus, according to another example of the present disclosure.

FIG. 13 is a flowchart illustrating a method for forwarding a multicast data packet using a non-gateway RB, according to an example of the present disclosure.

FIG. 14 is a flowchart illustrating a method for forwarding a multicast data packet using a gateway RB, according to an example of the present disclosure.

### DETAILED DESCRIPTION

Hereinafter, the present disclosure will be described in further detail with reference to the accompanying drawings and examples to make the technical solution and merits therein clearer.

In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, and the term “including” means including but not limited to. The term “based on” means based at least in part on. In addition, the terms “a” and “an” are intended to denote at least one of a particular element.

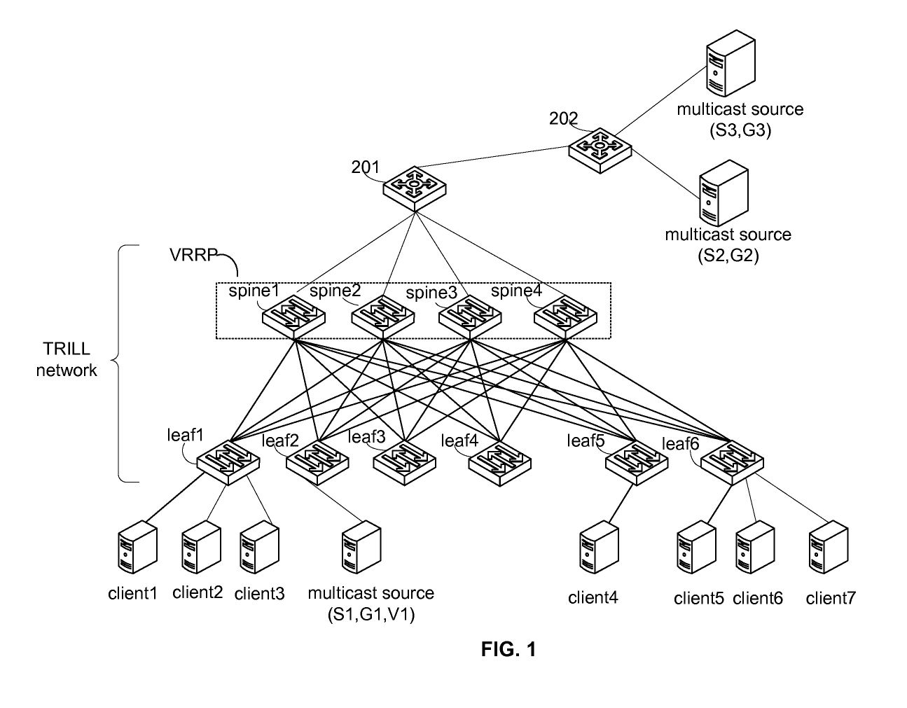

As shown in FIG. 1, four gateway routing bridges (RBs) at a core layer of a data center, i.e., the RBs spine1˜spine4, may perform neighbor discovery and election of a major device based on a virtual router redundancy (VRRP) protocol. The four RBs may form one VRRP router, which may be configured as a gateway of virtual local area network (VLAN) 1 and VLAN2. The RBs spine1˜spine4 may all be in an active state, and may route multicast data packets between VLAN1 and VLAN2. The gateway RBs spine1˜spine4 and the non-gateway RBs leaf1˜leaf6 are all depicted as being connected to each other.

An internet group management protocol snooping (IGSP) protocol may be run both on the gateway RBs spine1˜spine4 and on the non-gateway RBs leaf1˜leaf6 at the access layer. An internet group management protocol (IGMP) protocol and a PIM protocol may also be run on the RBs spine1˜spine4. The RBs spine1˜spine4 may record location information of a multicast source of each multicast group, which may indicate whether the multicast source is located inside the data center or outside the data center.

The RBs spine1˜spine4 may elect the RB spine1 as a designated router (DR) of VLAN1, may elect the RB spine3 as a DR of VLAN2, may elect the RB spine4 as an IGMP querier within VLAN1, and may elect the RB spine2 as an IGMP querier within VLAN2.

For convenience of description, six ports on the RB spine1 that may respectively connect the RB leaf1, the RB leaf2, the RB leaf3, the RB leaf4, theRB leaf5, and the RB leaf6 may be named as spine1_P1, spine1_P2, spine1_P3, spine1_P4, spine1_P5, and spine1_P6, respectively. The ports of the RBs spine2˜spine4 that may respectively connect the RBs leaf1˜leaf6 may be named according to the manners described above.

Four ports on the RB leaf1 that may respectively connect the RB spine1, the RB spine2, the RB spine3, and the RB spine4 may be named as leaf1_P1, leaf1_P2, leaf1_P3, and leaf1_P4, respectively. The ports of the RB leaf2˜the RB leaf6 that may respectively connect the RBs spine1 spine4 may be named according to the manners described above.

Three ports on the RB leaf1 that may respectively connect client1, client2, and client3 may be named as leaf1_Pa, leaf1_Pb, and leaf1_Pc, respectively. A port on the RB leaf5 that may connect to a client4 may be named as leaf5_Pa. Three ports on the RB leaf6 that may respectively connect to the clients, including client5, client6, and client7, may be named as leaf6_Pa, leaf6_Pb, and leaf6_Pc, respectively. The RB leaf2 may be connected with a multicast source (S1, G1, V1). The RBs spine1 spine4 may advertise, in a manner of notification, gateway information, DR information, and the location information of the multicast source within the TRILL network. Location information of a multicast source located inside the data center may be notified by a DR of a VLAN to which the multicast source belongs. Location information of a multicast source located outside the data center may be notified by each of the gateway RBs, or by each of the DRs. The client refers to a device which may be connected to a network, and can be a host, a server and any other type of device which can connect to a network.

In an example, the RB spine1 may advertise, in the TRILL network, that a nickname of a gateway of VLAN1 and VLAN2 may be a nickname of the RB spine1, a nickname of the DR in VLAN1 may be the nickname of the RB spine1, a multicast source of a multicast group G1 is located inside VLAN1 of the data center, and a multicast source of a multicast group G2 is located outside the data center. The RB spine2 may advertise, in the TRILL network, that a nickname of a gateway of VLAN1 and VLAN2 may be a nickname of the RB spine2, and that the multicast source of the multicast group G2 is located outside the data center. The RB spine3 may advertise, in the TRILL network, that a nickname of a gateway of VLAN1 and VLAN2 may be a nickname of the RB spine3, a nickname of the DR in VLAN2 may be the nickname of the RB spine3, the multicast source of the multicast group G2 is located outside the data center. The RB spine4 may advertise, in the TRILL network, that a nickname of a gateway of VLAN1 and VLAN2 may be a nickname of the RB spine4, and the multicast source of the multicast group G2 is located outside the data center.

The RBs spine1 spine4 may advertise the information described above through link state advertisement (LSA) of an intermediate system to intermediate system routing protocol (IS-IS). As such, link state databases maintained by the RBs in the TRILL domain may be synchronized. By this manner, the RBs spine1 spine4 and the RBs leaf1˜leaf6 may know that the gateways of VLAN1 and VLAN2 in the TRILL network may be the RB spine1˜spine4, the DR in VLAN1 may be the RB spine1, and the DR in VLAN2 may be the RB spine3.

The RBs spine1 spine4 and the RBs leaf1˜leaf6 may respectively calculate, taking the RB spine1, which is the DR of VLAN1 and the RB spine3, which is the DR of VLAN2 as roots, a TRILL multicast tree associated with VLAN1 and a TRILL multicast tree associated with VLAN2. The RBs spine1 spine4 and the RBs leaf1˜leaf6 may respectively calculate a TRILL multicast tree, which is rooted at the RB spine1 (i.e., the DR of VLAN1) and associated with VLAN1, and calculate a TRILL multicast tree, which is rooted at the RB spine3 (i.e., the DR of VLAN2) and is associated with VLAN2.

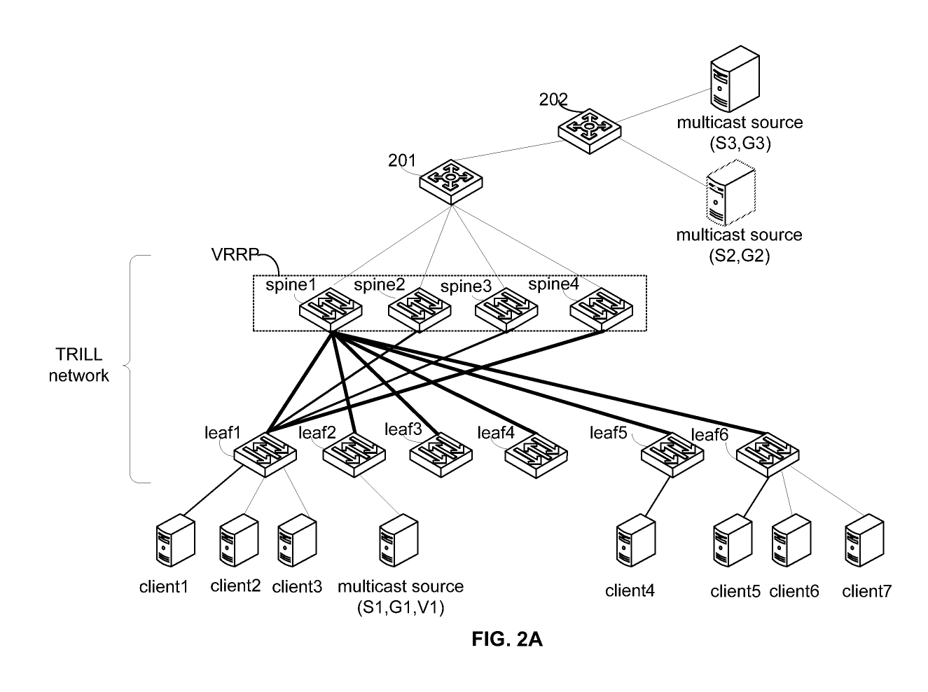

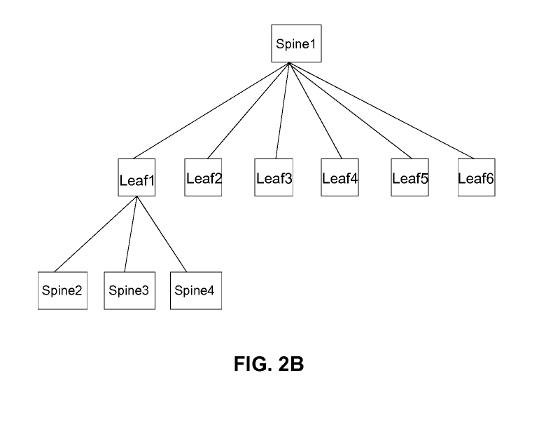

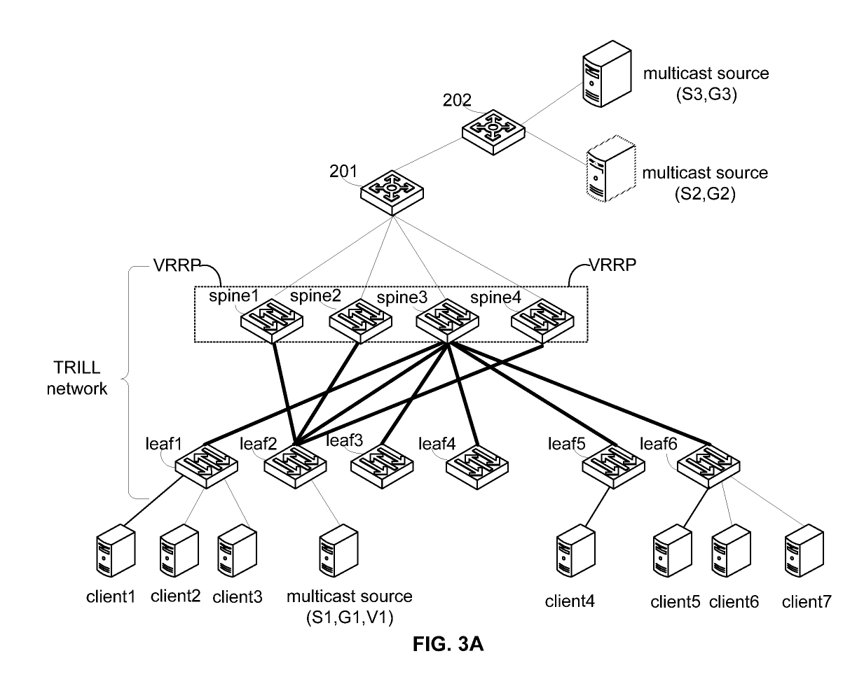

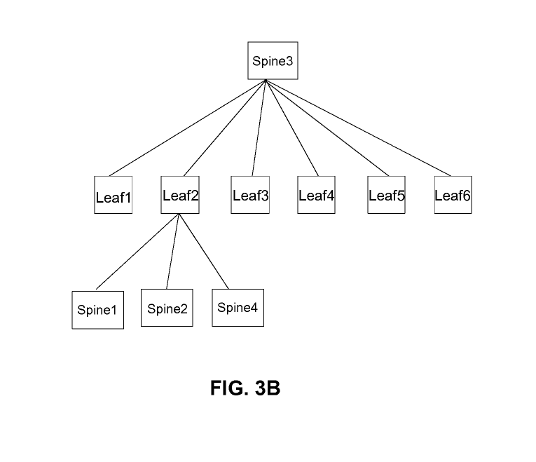

FIG. 2A is a schematic diagram illustrating the TRILL multicast tree of which the root is the RB spine1, according to an example of the present disclosure. FIG. 2B is an equivalent diagram of the TRILL multicast tree as shown in FIG. 2A. FIG. 3A is a schematic diagram illustrating the TRILL multicast tree of which the root is the RB spine3, according to an example of the present disclosure. FIG. 3B is an equivalent diagram of the TRILL multicast tree as shown in FIG. 3A.

The RBs spine1˜spine4 and the RBs leaf1˜leaf6 may respectively calculate, based on the TRILL multicast trees as shown in FIGS. 2A and 2B, a DR router port and a gateway router port of VLAN1. The RBs spine1˜spine4 and the RBs leaf1˜leaf6 may respectively calculate, based on the TRILL multicast trees as shown in FIGS. 3A and 3B, a DR router port and a gateway router port of VLAN2.

In an example of the present disclosure, a DR router port may be defined to mean a local port on a TRILL path on a TRILL multicast tree reaching a DR. A gateway router port may be defined to mean a local port on a TRILL path on a TRILL multicast tree reaching a gateway.

In the TRILL multicast trees as shown in FIGS. 2A and 2B, a TRILL path from the RB spine1 to itself may be through a loop interface. TRILL paths from the RB spine1 to the RBs spine2˜spine4 may respectively be spine1->leaf1->spine2, spine1->leaf1->spine3, and spine1->leaf1->spine4. As such, a DR router port of VLAN1 calculated by the RB spine1 may be null, a gateway router port of VLAN1 calculated by the RB spine1 may be port spine1_P1 (which may mean that the local ports of the RB spine1 on three TRILL paths that are from the RB spine1 to other three gateways of VLAN1 may all be the port spine1_P1).

In the TRILL multicast trees as shown in FIGS. 3A and 3B, a TRILL path from the RB spine1 to itself may be through a loop interface. TRILL paths from the RB spine1 to the RBs spine2˜spine4 may respectively be spine1->leaf2->spine2, spine1->leaf2->spine3, and spine1->leaf2->spine4. As such, a DR router port of VLAN2 calculated by the RB spine1 may be the port spine1_P2, and a gateway router port of VLAN2 calculated by the RB spine1 may be the port spine1_P2.

In the TRILL multicast trees as shown in FIGS. 2A and 2B, a TRILL path from the RB spine2 to the RB spine1 may be spine2->leaf1->spine1, a TRILL path from the RB spine2 to itself may be through a loop interface. TRILL paths from the RB spine2 to the RBs spine3 and spine4 may respectively be spine2->leaf1->spine3, and spine2->leaf1->spine4. As such, a DR router port of VLAN1 calculated by the RB spine2 may be the port spine2_P1, and a gateway router port of VLAN1 calculated by the RB spine2 may be the port spine2_P1 (which may mean that the local ports of the RB spine2 in three TRILL paths from the RB spine2 to the other three gateway RBs are the gateways of VLAN1 and may all be spine2_P1).

In the TRILL multicast trees as shown in FIGS. 3A and 3B, a TRILL path from the RB spine2 to the RB spine1 may be spine2->leaf2->spine1, a TRILL path from the RB spine2 to itself may be through a loop interface. TRILL paths from the RB spine2 to the RBs spine3 and spine4 may respectively be spine2->leaf2->spine3 and spine2->leaf2->spine4. As such, a DR router port of VLAN2 calculated by the RB spine2 may be the port spine2_P2, and a gateway router port of VLAN2 calculated by the RB spine2 may be the port spine2_P2 (which may mean that a router port of the RB spine2 that is directed towards itself is null, and a local port of spine2 in three TRILL paths that are from the RB spine2 to the other three gateways of VLAN2 may all be spine2_P2).

In the TRILL multicast trees as shown in FIGS. 2A and 2B, four TRILL paths from leaf1 to the RBs spine1˜spine4 may respectively be leaf1->spine1, leaf1->spine2, leaf1->spine3, and leaf1->spine4. As such, a DR router port of VLAN1 calculated by the RB leaf1 may be the port leaf1_P1, and the gateway router ports of VLAN1 calculated by the RB leaf1 may respectively be the ports leaf1_P1, leaf1_P2, leaf1_P3, and leaf4_P4 (which may mean that the local ports of leaf1 in the four TRILL paths that are from the RB leaf1 to the four gateways of VLAN1 may be different).

In the TRILL multicast trees as shown in FIGS. 3A and 3B, four TRILL paths from the RB leaf1 to the RBs spine1˜spine4 may respectively be leaf1->spine3->leaf2->spine1, leaf1->spine3->leaf2->spine2, leaf1->spine3, and leaf1->spine3->leaf2->spine4. As such, a DR router port of VLAN2 calculated by the RB leaf1 may be the port leaf1_P3, and a gateway router port of VLAN2 calculated by the RB leaf1 may be the port leaf1_P3 (which may mean that a local port of leaf1 in the four TRILL paths that are from the RB leaf1 to the four gateways of VLAN2 may all be leaf1_P3).

Manners in which the router ports may be calculated by the RBs spine3, spine4, and the RBs leaf2˜leaf6 based on the TRILL multicast trees as shown in FIGS. 2A, 2B, 3A, and 3B may be similar to the manners described above, which are not repeated herein.

Router ports calculated by the RB spine1 based on the TRILL multicast trees as shown in FIGS. 2A, 2B, 3A, and 3B may be as shown in Table 1.1.

TABLE 1.1

| VLAN | DR router port | Gateway router port |
|---|---|---|
| V1 | (null) | spine1_P1 |
| V2 | spine1_P2 | spine1_P2 |

Router ports calculated by the RB spine2 based on the TRILL multicast trees as shown in FIGS. 2A, 2B, 3A, and 3B may be as shown in Table 1.2.

TABLE 1.2

| VLAN | DR router port | Gateway router port |
|---|---|---|
| V1 | spine2_P1 | spine2_P1 |
| V2 | spine2_P2 | spine2_P2 |

Router ports calculated by the RB spine3 based on the TRILL multicast trees as shown in FIGS. 2A, 2B, 3A, and 3B may be as shown in Table 1.3.

TABLE 1.3

| VLAN | DR router port | Gateway router port |
|---|---|---|
| V1 | spine3_P1 | spine3_P1 |
| V2 | null | spine3_P2 |

Router ports calculated by the RB spine4 based on the TRILL multicast trees as shown in FIGS. 2A, 2B, 3A, and 3B may be as shown in Table 1.4.

TABLE 1.4

| VLAN | DR router port | Gateway router port |
|---|---|---|
| V1 | spine4_P1 | spine4_P1 |
| V2 | spine4_P2 | spine4_P2 |

Router ports calculated by the RB leaf1 based on the TRILL multicast trees as shown in FIGS. 2A, 2B, 3A, and 3B may be as shown in Table 2.1.

TABLE 2.1

| VLAN | DR router port | Gateway router port |
|---|---|---|
| V1 | leaf1_P1 | leaf1_P1; leaf1_P2 |
| | | leaf1_P3; leaf1_P4 |
| V2 | leaf1_P3 | leaf1_P3 |

Router ports calculated by the RB leaf2 based on the TRILL multicast trees as shown in FIGS. 2A, 2B, 3A, and 3B may be as shown in Table 2.2.

TABLE 2.2

| VLAN | DR router port | Gateway router port |
|---|---|---|
| V1 | leaf2_P1 | leaf2_P1 |
| V2 | leaf2_P3 | leaf2_P1; leaf2_P2 |
| | | leaf2_P3; leaf2_P4 |

Router ports calculated by the RB leaf3 based on the TRILL multicast trees as shown in FIGS. 2A, 2B, 3A, and 3B may be as shown in Table 2.3.

TABLE 2.3

| VLAN | DR router port | Gateway router port |
|---|---|---|
| V1 | leaf3_P1 | leaf3_P1 |
| V2 | leaf3_P3 | leaf3_P3 |

Router ports calculated by the RB leaf4 based on the TRILL multicast trees as shown in FIGS. 2A, 2B, 3A, and 3B may be as shown in Table 2.4.

TABLE 2.4

| VLAN | DR router port | Gateway router port |
|---|---|---|
| V1 | leaf4_P1 | leaf4_P1 |
| V2 | leaf4_P3 | leaf4_P3 |

Router ports calculated by the RB leaf5 based on the TRILL multicast trees as shown in FIGS. 2A, 2B, 3A, and 3B may be as shown in Table 2.5.

TABLE 2.5

| VLAN | DR router port | Gateway router port |
|---|---|---|
| V1 | leaf5_P1 | leaf5_P1 |
| V2 | leaf5_P3 | leaf5_P3 |

Router ports calculated by the RB leaf6 based on the TRILL multicast trees as shown in FIGS. 2A, 2B, 3A, and 3B may be as shown in Table 2.6.

TABLE 2.6

| VLAN | DR router port | Gateway router port |
|---|---|---|
| V1 | leaf6_P1 | leaf6_P1 |
| V2 | leaf6_P3 | leaf6_P3 |

In an example of the present disclosure, each of the RBs may calculate, for a multicast group of which a multicast source may be located inside the data center, a DR router port and a gateway router port. Each of the RBs may calculate, for a multicast group of which a multicast source may be located outside the data center, a DR router port.

“Router port associated with a multicast group” calculated by the RB spine1 may be as shown in Table 3.1.

TABLE 3.1

| | Multicast | | |
|---|---|---|---|
| VLAN | group | DR router port | Gateway router port |
| V1 | G1 | (null) | spine1_P1 |
| V1 | G2 | (null) | |
| V1 | G3 | (null) | |
| V2 | G1 | spine1_P2 | spine1_P2 |
| V2 | G2 | spine1_P2 | |
| V2 | G3 | spine1_P2 | |

“Router port associated with a multicast group” calculated by the RB spine2 may be as shown in Table 3.2.

TABLE 3.2

| | Multicast | | |
|---|---|---|---|
| VLAN | group | DR router port | Gateway router port |
| V1 | G1 | spine2_P1 | spine2_P1 |
| V1 | G2 | spine2_P1 | |
| V1 | G3 | spine2_P1 | |
| V2 | G1 | spine2_P2 | spine2_P2 |
| V2 | G2 | spine2_P2 | |
| V2 | G3 | spine2_P2 | |

“Router port associated with a multicast group” calculated by the RB spine3 may be as shown in Table 3.3.

TABLE 3.3

| | Multicast | | |
|---|---|---|---|
| VLAN | group | DR router port | Gateway router port |
| V1 | G1 | spine3_P1 | spine3_P1 |
| V1 | G2 | spine3_P1 | |
| V1 | G3 | spine3_P1 | |
| V2 | G1 | (null) | spine3_P2 |
| V2 | G2 | (null) | |
| V2 | G3 | (null) | |

“Router port associated with a multicast group” calculated by the RB spine4 may be as shown in Table 3.4.

TABLE 3.4

| | Multicast | | |
|---|---|---|---|
| VLAN | group | DR router port | Gateway router port |
| V1 | G1 | spine4_P1 | spine4_P1 |
| V1 | G2 | spine4_P1 | |
| V1 | G3 | spine4_P1 | |
| V2 | G1 | spine4_P2 | spine4_P2 |
| V2 | G2 | spine4_P2 | |
| V2 | G3 | spine4_P2 | |

“Router port associated with a multicast group” calculated by the RB leaf1 may be as shown in Table 4.1.

TABLE 4.1

| | Multicast | | |
|---|---|---|---|
| VLAN | group | DR router port | Gateway router port |
| V1 | G1 | leaf1_P1 | leaf1_P1, leaf1_P2, |
| | | | leaf1_P3, leaf1_P4 |
| V1 | G2 | leaf1_P1 | |
| V1 | G3 | leaf1_P1 | |
| V2 | G1 | leaf1_P3 | leaf1_P3 |
| V2 | G2 | leaf1_P3 | |
| V2 | G3 | leaf1_P3 | |

“Router port associated with a multicast group” calculated by the RB leaf2 may be as shown in Table 4.2.

TABLE 4.2

| | Multicast | | |
|---|---|---|---|
| VLAN | group | DR router port | Gateway router port |
| V1 | G1 | leaf2_P1 | leaf2_P1 |
| V1 | G2 | leaf2_P1 | |
| V1 | G3 | leaf2_P1 | |
| V2 | G1 | leaf2_P3 | leaf2_P1, leaf2_P2, |
| | | | leaf2_P3, leaf2_P4 |
| V2 | G2 | leaf2_P3 | |
| V2 | G3 | leaf2_P3 | |

“Router port associated with a multicast group” calculated by the RB leaf3 may be as shown in Table 4.3.

TABLE 4.3

| | Multicast | | |
|---|---|---|---|
| VLAN | group | DR router port | Gateway router port |
| V1 | G1 | leaf3_P1 | leaf3_P1 |
| V1 | G2 | leaf3_P1 | |
| V1 | G3 | leaf3_P1 | |
| V2 | G1 | leaf3_P3 | leaf3_P3 |
| V2 | G2 | leaf3_P3 | |
| V2 | G3 | leaf3_P3 | |

“Router port associated with a multicast group” calculated by the RB leaf4 may be as shown in Table 4.4.

TABLE 4.4

| | Multicaset | | |
|---|---|---|---|
| VLAN | goup | DR router port | Gateway router port |
| V1 | G1 | leaf4_P1 | leaf4_P1 |
| V1 | G2 | leaf4_P1 | |
| V1 | G3 | leaf4_P1 | |
| V2 | G1 | leaf4_P3 | leaf4_P3 |
| V2 | G2 | leaf4_P3 | |
| V2 | G3 | leaf4_P3 | |

“Router port associated with a multicast group” calculated by the RB leaf5 may be as shown in Table 4.5.

TABLE 4.5

| | Multicast | | |
|---|---|---|---|
| VLAN | group | DR router port | Gateway router port |
| V1 | G1 | leaf5_P1 | leaf6_P1 |
| V1 | G2 | leaf5_P1 | |
| V1 | G3 | leaf5_P1 | |
| V2 | G1 | leaf5_P3 | leaf5_P3 |
| V2 | G2 | leaf5_P3 | |
| V2 | G3 | leaf5_P3 | |

“Router port associated with a multicast group” calculated by the RB leaf6 may be as shown in Table 4.6.

TABLE 4.6

| | Multicast | | |
|---|---|---|---|
| VLAN | group | DR router port | Gateway router port |
| V1 | G1 | leaf6_P1 | leaf6_P1 |
| V1 | G2 | leaf6_P1 | |
| V1 | G3 | leaf6_P1 | |
| V2 | G1 | leaf6_P3 | leaf6_P3 |
| V2 | G2 | leaf6_P3 | |
| V2 | G3 | leaf6_P3 | |

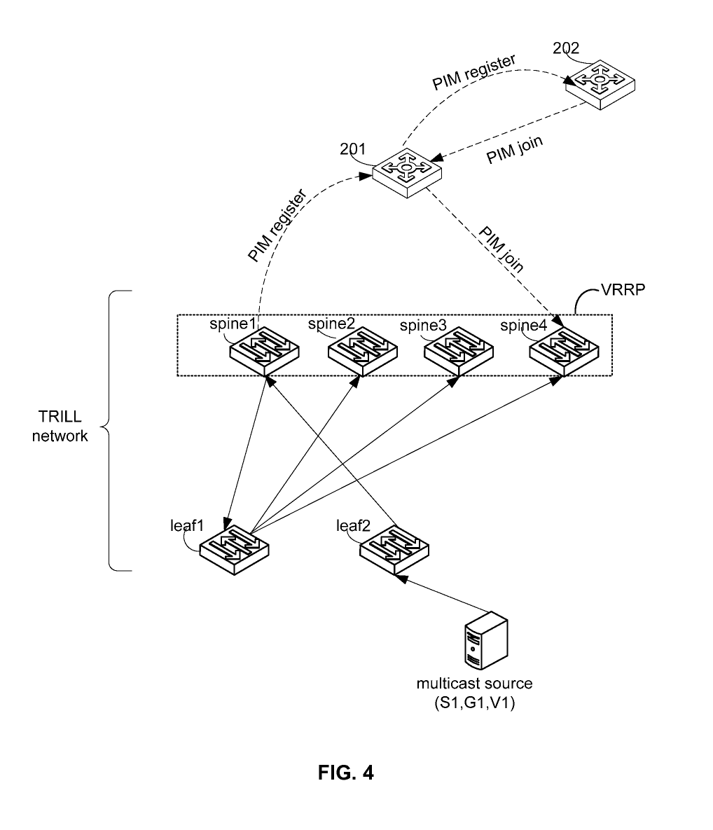

FIG. 4 is a schematic diagram illustrating a process of sending a PIM register packet to an external RP router as shown in FIG. 2, according to an example of the present disclosure. The multicast source (S1, G1, V1) of the multicast group G1, which may be located inside VLAN1 of the data center, may send a multicast data packet to group G1.

The RB leaf2 may receive the multicast data packet, and may not find an entry matching with (VLAN1, G1). The RB leaf2 may configure a new (S1, G1, V1) entry, and may add the port leaf2_P1, which is both the gateway router port and the DR router port of VLAN1 (with reference to Table 4.2), to an outgoing interface of the newly-configured (S1, G1, V1) entry.

The RB leaf2 may send, through leaf2_P1 which may be the router port towards the DR of VLAN1, the data packet with the multicast group G1 of VLAN1 to spine1.

The RB spine1 may receive the data packet having multicast address G1 and VLAN1 at the port spine1_P1, and may not find an entry matching with the multicast address G1. The RB spine1 may configure a (S1, G1, V1) entry, and may add membership information (VLAN1, spine1_P1) to an outgoing interface of the newly-configured (S1, G1, V1) entry, in which VLAN1 may be a virtual local area network identifier (VLAN ID) of the multicast data packet, and spine1_P1 may be a gateway router port of VLAN1. The RB spine1, as the DR of VLAN1, may encapsulate the multicast data packet into a PIM register packet, and may send the PIM register packet to an upstream multicast router, i.e., an outgoing router 201. The outgoing router 201 may send the PIM register packet towards the RP router 202.

The RB spine1 may duplicate and send, based on the newly-added membership information (VLAN1, spine1_P1), the data packet having multicast address G1 and VLAN1. The RB leaf1 may receive the data packet having multicast address G1 and VLAN1 at the port leaf1_P1, and may not find an entry matching with (VLAN1, G1).

The RB leaf1 may configure a (S1, G1, V1) entry, and may add the ports leaf1_P1, leaf1_P2, leaf1_P3, and leaf1_P4, which are the DR router port and the gateway router ports of the VLAN1, to an outgoing interface of the newly-configured entry. The RB leaf1 may send, respectively through the ports leaf1_P2, leaf1_P3, and leaf1_P4, which are the gateway router ports of VLAN1, the data packet having the multicast address G1 and VLAN1 to the RBs spine2, spine3, and spine4. The leaf 1 may not send the multicast data packet via the DR router port leaf1_P1 of VLAN1 due to the incoming interface of the received multicast data packet also being the DR router port leaf1_P1.

Each of the RBs spine2, spine3, and spine4 may receive the packet having the multicast address G1 and VLAN1, and may not find an entry matching with the multicast address G1. The RB spine2 may configure a (S1, G1, V1) entry, and may add membership information (VLAN1, spine2_p1) to an outgoing interface of the newly-configured entry, in which VLAN1 may be a VLAN ID of the multicast data packet, and spine2_P1 may be the gateway router port of VLAN1. The RB spine3 may configure a (S1, G1, V1) entry, and may add membership information (VLAN1, spine3_p1) to an outgoing interface of the newly-configured entry, in which VLAN1 may be a VLAN ID of the multicast data packet, and spine3_P1 may be the gateway router port of VLAN1. The RB spine4 may configure a (S1, G1, V1) entry, and may add membership information (VLAN1, spine4_p1) to an outgoing interface of the newly-configured entry, in which VLAN1 may be a VLAN ID of the multicast data packet, and spine4_P1 may be the gateway router port of VLAN1. The RBs spine2, spine3, and spine4 may not duplicate the multicast data packets based on their newly added membership information, which is the same as the incoming interfaces of the incoming data packet having the multicast address G1 and VLAN1.

The RP router 202 may receive and decapsulate the PIM register packet to get the multicast data packet, and may send the multicast data packet to a receiver of the multicast G1 that is located outside of the data center. The RP router 202 may send, according to a source IP address of the PIM register packet, a PIM (S1, G1) join packet to join the multicast group G1. The PIM join packet may be transmitted hop-by-hop to the outgoing router 201 of the data center. The outgoing router 201 may receive the PIM join packet, and may select the RB spine4 from the RBs spine1˜spine4, which are the next-hops of the VLAN1. The outgoing router 201 may send a PIM join packet to the RB spine4 to join the multicast group G1. In an example, the outgoing router 201 may perform HASH calculation according to the PIM join packet requesting to join the multicast group G1, and may select the next hop based on a result of the HASH calculation.

The RB spine4 may receive, through a local port spine4_Pout (which is not shown in FIG. 4), the PIM join packet to join the multicast group G1, find the (S1, G1, V1) entry based on the multicast address G1, and add membership information (VLAN100, spine4_Pout) to an outgoing interface of the matching entry, in which VLAN100 may be a VLAN ID of the PIM join packet, and spine4_Pout may be a port receiving the PIM join packet. In an example, if the next hop selected by the outgoing router 201 is the RB spine1, the RB spine1 may add associated membership information according to the PIM join packet received.

### Processing for Joining a Multicast Group

Hereinafter, processes that the receivers inside the data center including client1˜client7 respectively join a corresponding multicast group will be described in further detail.

### The Client 1 Joins the Multicast Group G1

In an example, the client1 which belongs to VLAN1 may send an IGMP report packet requesting to join the multicast group (*, G1).

The RB leaf1 may receive the IGMP report packet through the port leaf1_Pa, find the (S1, G1, V1) entry matching with (VLAN1, G1), add a membership port leaf1_Pa to the outgoing interface of the matching entry, and configure an aging timer for the membership port leaf1_Pa.

The RB leaf1 may encapsulate a TRILL header and a next-hop header for the received IGMP report packet to encapsulate the IGMP report packet as a TRILL-encapsulated IGMP report packet, in which an ingress nickname of the TRILL header may be a nickname of the RB leaf1, and an egress nickname of the TRILL header may be a nickname of the RB spine1 (which is the DR of VLAN1). The RB leaf1 may send the TRILL-encapsulated IGMP report packet through the port leaf1_P1 (with reference to Table 1.1 and Table 4.1) which is the DR router port of VLAN1.

The RB spine1 may receive the TRILL-encapsulated IGMP report packet through the port spine1_P1, find the (S1, G1, V1) entry matching the multicast address G1, determine that membership information (VLAN1, spine1_P1) has already existed in the matching entry, and may not repeatedly record the membership information. The RB spine1 may configure an aging timer for spine1_P1 (which is a port receiving the TRILL-format IGMP report packet), which is a membership port of the membership information (VLAN1, spine1_P1).

The RB spine1, as the DR of VLAN1, may send a PIM join packet to the RP router 202 to join the multicast group G1.

### The Client 2 Joins the Multicast Group G2

In an example, the client2, which belongs to VLAN1, may send an IGMP report packet requesting to join the multicast group (*, G2).

The RB leaf1 may receive the IGMP report packet requesting to join the multicast group G2 through the port leaf1_Pb and may not find an entry matching with (VLAN1, G2). The RB leaf1 may configure a (*, G2, V1) entry, add leaf1_Pb (which is a port receiving the IGMP report packet) as a membership port to an outgoing interface of the newly-configured entry, and configure an aging timer for the membership port leaf1_Pb.

The RB leaf1 may encapsulate the IGMP report packet as a TRILL-encapsulated IGMP report packet, in which an ingress nickname of a TRILL header may be a nickname of the RB leaf1, and an egress nickname of the TRILL header may be a nickname of the RB spine1 (which is the DR of VLAN1). The RB leaf1 may send the TRILL-encapsulated IGMP report packet through the port leaf1_P1 (with reference to Table 2.1 and Table 4.1) which is the DR router port of VLAN1.

The RB spine1 may receive the TRILL-encapsulated IGMP report packet, and may not find an entry matching with the multicast address G2. The RB spine2 may configure a (*, G2, V1) entry, and may add membership information (VLAN1, spine1_P1) to the newly-configured entry, in which VLAN1 may be a VLAN ID of the IGMP report packet, and the port spine1_P1 (which is a port receiving the TRILL-format IGMP report packet) may be a membership port. The RB spine1 may configure an aging timer for spine1_P1, which is the membership port in the membership information (VLAN1, spine1_P1).

The RB spine1, as the DR of VLAN1, may send a PIM join packet to the RP router 202 of the multicast group G2.

### The Client 3 Joins the Multicast Group G3

In an example, the client3, which belongs to VLAN1, may send an IGMP report packet requesting to join the multicast group (*, G3).

The RB leaf1 may receive the IGMP report packet requesting to join the multicast group G3 through the port leaf1_Pc and may not find an entry matching with (VLAN1, G3). The RB leaf1 may configure a (*, G3, V1) entry, add a membership port leaf1_Pc to an outgoing interface of the newly-configured entry, and may configure an aging timer for the membership port leaf1_Pc.

The RB leaf1 may encapsulate the IGMP report packet as a TRILL-encapsulated IGMP report packet, in which an ingress nickname of a TRILL header may be a nickname of the RB leaf1, and an egress nickname of the TRILL header may be a nickname of the RB spine1 (which is the DR of VLAN1). The RB leaf1 may send the TRILL-encapsulated IGMP report packet through port leaf1_P1 (with reference to Table 2.1 and Table 4.1) which is the DR router port of VLAN1.

The RB spine1 may receive the TRILL-encapsulated IGMP report packet through the port spine1_P1 and may not find an entry matching with a multicast address G3. The RB spine1 may configure a (*, G3, V1) entry, add membership information (VLAN1, spine1_P1) to an outgoing interface of the newly-configured entry, in which VLAN1 may be a VLAN ID of the IGMP report packet, and spine1_P1 may be a membership port. The RB spine1 may configure an aging timer for the membership port spine1_P1 in the membership information (VLAN1, spine1_P1).

The RB spine1, as the DR of VLAN1, may send a PIM join packet to the RP router 202 of the multicast group G3.

### The Client 4 Joins the Multicast Group G2

In an example, the client4 may join the multicast group G2. A process that the client4 joins the multicast group G2 may be similar to the process that the client2 joins the multicast group G2. In the example, the client4, which belongs to VLAN1, may send an IGMP report packet requesting to join multicast group (*, G2).

The RB leaf5 may receive the IGMP report packet through the port leaf5_Pa, configure a (*, G2, V1) entry, add a membership port leaf5_Pa to the newly-configured entry, and configure an aging timer for the membership port leaf5_Pa.

The RB leaf5 may encapsulate the IGMP report packet as a TRILL-encapsulated IGMP report packet, and may send the TRILL-encapsulated IGMP report packet through the port leaf5_P1 (with reference to Table 2.5 and Table 4.5) which is the DR router port of VLAN1.

The RB spine1 may receive the TRILL-encapsulated IGMP report packet, find the (*, G2, V1) entry matching with a multicast address G2, add a membership information (VLAN1, spine1_P5) to the matching (*, G2, V1) entry, and may configure an aging timer for the membership port spine1_P5 in the membership information (VLAN1, spine1_P5).

The RB spine1, as the DR of VLAN1, has already sent the PIM join packet to the RP router 202 to join the multicast group G2, and may not repeatedly send the PIM join packet to the multicast group G2.

### The Client 5 Joins the Multicast Group G2

In an example, the client5 may join the multicast group G1. A process in which the client5 joins to the multicast group G1 may be similar to the process in which the client1 joins to the multicast group G1. In the example, the client5, which belongs to VLAN1, may send an IGMP report packet requesting to join the multicast group (*, G1).

The RB leaf6 may receive the IGMP report packet through the port leaf6_Pa, configure a (*, G1, V1) entry, add a membership port leaf6_Pa to an outgoing interface of the newly-configured entry, and may configure an aging timer for the membership port leaf6_Pa.

The RB leaf6 may encapsulate the IGMP report packet as a TRILL-encapsulated IGMP report packet, and may send the TRILL-encapsulated IGMP report packet through the port leaf6_P1 (with reference to Table 2.6 and Table 4.6) which is the DR router port of VLAN1.

The RB spine1 may receive the TRILL-encapsulated IGMP report packet, find the (S1, G1, V1) entry matching with the multicast address G1, add membership information (VLAN1, spine1_P6) to the matching (S1, G1, V1) entry, and configure an aging timer for spine1_P6 which is the membership port of the membership information (VLAN1, spine1_P6).

### The Client 6 Joins the Multicast Group G1

In an example, the client6 may join the multicast group G1. In the example, the client6, which belongs to VLAN2, may send an IGMP report packet requesting to join the multicast group (*, G1).

The RB leaf6 may receive the IGMP report packet requesting to join the multicast group G1 through the port leaf6_Pb and may not find an entry matching with (VLAN2, G1). The RB leaf6 may configure a (*, G1, V2) entry, add a membership port leaf6_Pb to an outgoing interface of the newly-configured entry, and may configure an aging timer for the membership port leaf6_Pb.

The RB leaf6 may encapsulate the IGMP report packet as a TRILL-encapsulated IGMP report packet, in which an ingress nickname of a TRILL header may be a nickname of the RB leaf6, and an egress nickname of the TRILL header may be a nickname of the RB spine3 (which is the DR of VLAN2). The RB leaf6 may send the TRILL-encapsulated IGMP report packet through the port leaf6_P3 (with reference to Table 2.6 and Table 4.6) which is the DR router port of VLAN2.

The RB spine3 may receive the TRILL-encapsulated IGMP report packet through port spine3_P6, find the (S1, G1, V1) entry matching with the multicast address G1, add membership information (VLAN2, spine3_P6) to the matching entry, in which VLAN1 may be a VLAN ID of the IGMP report packet, and spine3_P6 (which may be a port receiving the TRILL-encapsulated IGMP report packet) may be a membership port. The RB spine3 may configure an aging timer for the membership port spine3_P6 of the membership information (VLAN2, spine3_P6).

The RB spine3, as the DR of VLAN2, may send a PIM join packet to the RP router 202 to join the multicast group G1.

### The Client 7 Joins the Multicast Group G2

In an example, the client7 may join the multicast group G2. In the example, the client7, which belongs to VLAN2, may send an IGMP report packet to join the multicast group (*, G2).

The RB leaf6 may receive the IGMP report packet joining the multicast group G2 through the port leaf6_Pc and may not find an entry matching with (VLAN2, G2). The RB leaf6 may configure a (*, G2, V2) entry, add a membership port leaf6_Pc to an outgoing interface of the newly-configured entry, and may configure an aging timer for the membership port leaf6_Pc.

The RB leaf6 may encapsulate the IGMP report packet as a TRILL-encapsulated IGMP report packet, in which an ingress nickname of a TRILL header may be a nickname of leaf6, and an egress nickname of the TRILL header may be a nickname of the RB spine3 (which is the DR of VLAN2). The RB leaf6 may send the TRILL-encapsulated IGMP report packet through leaf6_P3 (with reference to Table 2.6 and Table 4.6) which is the DR router port of VLAN2.

The RB spine3 may receive the TRILL-encapsulated IGMP report packet and may not find an entry matching with the multicast address G2. The RB spine3 may configure a (*, G2, V2) entry, add membership information (VLAN2, spine3_P6) to the newly-configured entry, and configure an aging timer for spine3_P6 which is the membership port of the membership information (VLAN2, spine3_P6).

The RB spine3, as the DR of VLAN2, may send a PIM join packet requesting to join the multicast group G2 to the RP router 202.

The entries of the RB spine1 may be as shown in Table 5.1.

TABLE 5.1

| Entry | Outgoing interface |
|---|---|
| (S1, G1, V1) | (VLAN1, spine1_P1) |
| | (VLAN1, spine1_P6) |
| (*, G2, V1) | (VLAN1, spine1_P1); |
| | (VLAN1, spine1_P5); |
| (*, G3, V1) | (VLAN1, spine1_P1) |

The entries of the RB spine2 may be as shown in Table 5.2.

TABLE 5.2

| Entry | Outgoing interface |
|---|---|
| (S1, G1, V1) | (VLAN1, spine2_P1) |

The entries of the RB spine3 may be as shown in Table 5.3.

TABLE 5.3

| Entry | Outgoing interface |
|---|---|
| (S1, G1, V1) | (VLAN1, spine3_P1) |
| | (VLAN2, spine3_P6) |
| (*, G2, V2) | (VLAN2, spine3_P6) |

The entries of the RB spine4 may be as shown in Table 5.4.

TABLE 5.4

| Entry | Outgoing interface |
|---|---|
| (S1, G1, V1) | (VLAN 1, spine4_P1) |
| | (VLAN 100, spine4_Pout) |

The entries of the RB leaf1 may be as shown in Table 6.1.

TABLE 6.1

| Entry | Outgoing interface |
|---|---|
| (S1, G1, V1) | leaf1_P1, leaf1_P2, |
| | leaf1_P3, leaf1_P4, leaf1_Pa |
| (*, G2, V1) | leaf1_Pb |
| (*, G3, V1) | leaf1_Pc |

The entries of the RB leaf2 may be as shown in Table 6.2.

TABLE 6.2

| Entry | Outgoing interface |
|---|---|
| (S1, G1, V1) | leaf2_P1 |

The entries of the RB leaf5 may be as shown in Table 6.3.

TABLE 6.3

| Entry | Outgoing interface |
|---|---|
| (*, G2, V1) | leaf5_Pa |

The entries of the RB leaf6 may be as shown in Table 6.4.

TABLE 6.4

| Entry | Outgoing interface |
|---|---|
| (*, G1, V1) | leaf6_Pa |
| (*, G1, V2) | leaf6_Pb |
| (*, G2, V2) | leaf6_Pc |

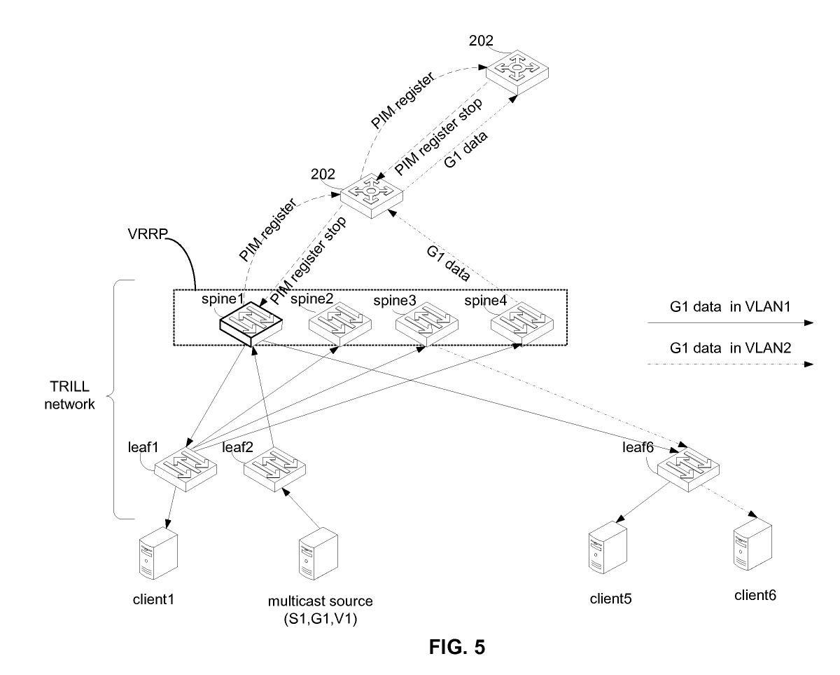

FIG. 5 is a schematic diagram illustrating a process of sending a multicast data packet of an internal multicast source as shown in FIG. 2 to an internal multicast group receiving end and an external RP router, according to an example of the present disclosure.

In this case, the multicast source (S1, G1, V1) of the multicast group G1 may send a multicast data packet to the RB leaf2. The RB leaf2 may find the local (S1, G1, V1) entry matching with (VLAN1, G1), and may send the multicast data packet to the RB spine1 through the port leaf2_P1, which is both the router port of the VLAN1 and the gateway router port of the VLAN1, in the matching entry.

The RB spine1 may receive the multicast data packet, find a local (S1, G1, V1) entry matching with (VLAN1, G1), and duplicate and send the data packet of the multicast group G1 based on the membership information (VLAN1, spine1_P1) and (VLAN1, spine1_P6) in the matching (S1, G1, V1) entry. As such, the RB spine1 may send the multicast packet having the multicast address G1 and VLAN1 to the RBs leaf1 and leaf6. The RB spine1 may encapsulate the multicast data packet as a PIM register packet and may send the PIM register packet towards the RP router 202.

The RB leaf6 may receive the multicast packet having the multicast address G1 and VLAN1, find the (*, G1, V1) entry matching with (VLAN1, G1), and may send the packet having the multicast address G1 and VLAN1 to the client5 through leaf6_Pa, which is a membership port in the matching (*, G1, V1) entry.

The RB leaf1 may receive the packet having the multicast address G1 and VLAN1, find the (S1, G1, V1) entry matching with (VLAN1, G1), send the packet having the multicast address G1 and VLAN to the client1 through the membership port leaf1_Pa in the matching (S1, G1, V1) entry, and may send the packet having the multicast address G1 and VLAN1 to the RBs spine2, spine3, and spine4 respectively through leaf1_P2, leaf1_P3, and leaf1_P4 which are the DR router port and the gateway router port of VLAN1 in the matching entry.

The RB spine2 may receive the packet with the multicast address G1 of VLAN1, and may not duplicate and forward the packet due to a fact that membership information in a (S1, G1, V1) entry matching with (VLAN1, G1) is the same as an incoming interface of the packet (i.e., a port receiving the packet).

The RB spine3 may receive the data packet having the multicast address G1 and VLAN1, find a (S1, G1, V1) entry matching with (VLAN1, G1), and may duplicate and send the data packet having the multicast address G1 and VLAN1 based on membership information (VLAN2, spine3_P6) in the matching entry. As such, the RB spine3 may send a data packet having the multicast address G1 and VLAN2 to the RB leaf6. The RB leaf6 may receive the data packet having the multicast address G1 and VLAN2 find the (*, G1, V2) entry matching with (VLAN2, G1), and may send the data packet having the multicast address G1 and VLAN2 to the client6 through the membership port leaf6_Pb in the matching (*, G1, V2) entry.

The RB spine4 may receive the data packet having the multicast address G1 and VLAN1, find the (S1, G1, V1) entry matching with (VLAN1, G1), duplicate and send the data packet having the multicast address G1 and VLAN1 based on the membership information (VLAN100, spine4_Pout) in the matching entry, and may send the packet of the multicast group G1 to the outgoing router 201. The outgoing router 201 may send the packet of the multicast group G1 towards the RP router 202.

The RP router 202 may receive the multicast data packet, and may send to the RB spine1 a PIM register-stop packet of the multicast group G1. The RB spine1 may receive the PIM register-stop packet, and stop sending the PIM register packet to the RP router 202.

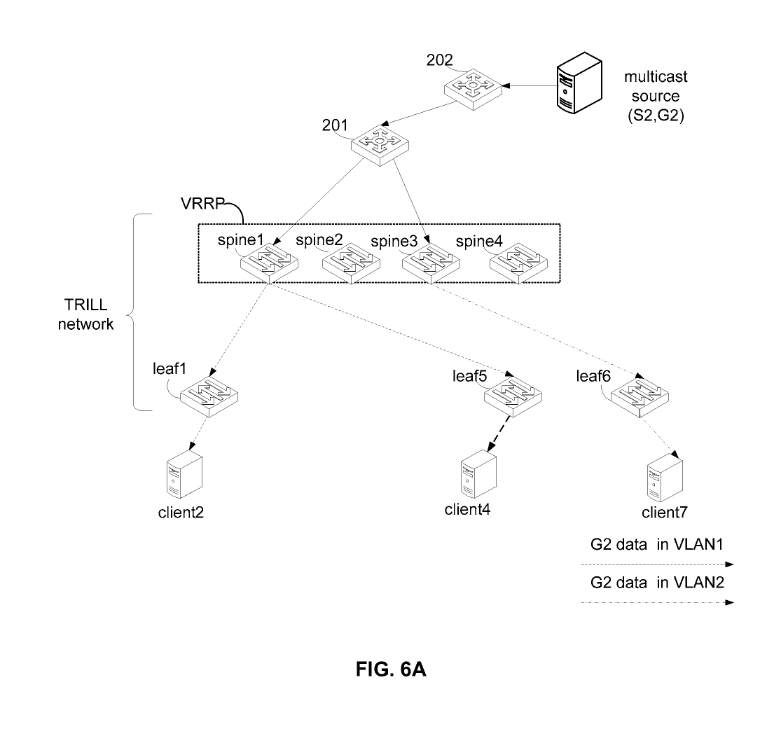

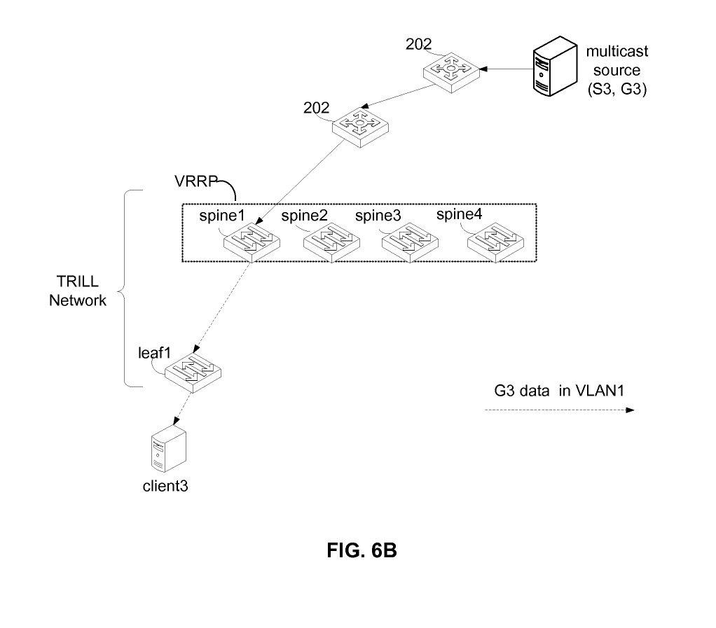

As shown in FIG. 6A, the RP router 202 may receive a packet sent from a multicast source (S2, G2) located outside the data center, and may send, based on a shared tree of the multicast group G2, the packet of the multicast group G2 to the RBs spine1 (which is the DR of VLAN1) and spine3 (which is the DR of VLAN2).

The RB spine1 may receive the multicast data packet of the multicast group G2, find the entry matching with the multicast address G2, and may duplicate and send the packet of the multicast group G2 according to the membership information (VLAN1, spine1_P1) and (VLAN1, spine1_P5) of the outgoing interfaces in the matching entry (*, G2, V1). The RB spine1 may send the data packet having the multicast address G2 and VLAN1 to the RBs leaf1 and leaf5. The RB leaf1 may receive the data packet having the multicast address G2 and VLAN1, find the (*, G2, V1) entry matching with (VLAN1, G2), and may send the data packet having the multicast address G2 and VLAN1 to the client2 through the membership port RB leaf1_Pb in the outgoing interface of the matching (*, G2, V1) entry. The RB leaf5 may receive the data packet having the multicast address G2 and VLAN1, find the (*, G2, V1) entry matching with (VLAN1, G2), and may send the data packet having the multicast address G2 and VLAN1 the client4 through membership port leaf5_Pa in the outgoing interface of the matching (*, G2, V1) entry.

The RB spine3 may receive the multicast data packet sent to the multicast group G2, find the (*, G2, V2) entry matching with the multicast address G2, and may duplicate and send the multicast data packet of the multicast group G2 based on the membership information (VLAN2, spine1_P6) of the outgoing interface information in the matching entry (*, G2, V2). The RB spine3 may send the packet multicast data packet having the multicast address G2 and VLAN2 the RB leaf6. The RB leaf6 may receive the data packet having the multicast address G2 and VLAN2, find a (*, G2, V2) entry matching with (VLAN2, G2), and may send the data packet having the multicast address G2 and VLAN2 to the client7 through membership port leaf6_Pc in the outgoing interface of the matching (*, G2, V2) entry.

As shown in FIG. 6B, the RP router 202 may receive a data packet sent from a multicast source (S3, G3) located outside the data center, and may send the data packet of the multicast group G3 to the RB spine1 (which is the DR of VLAN1) based on a shared tree of the multicast group G3.

The RB spine1 may receive the multicast data packet of the multicast group G3, find a (*, G3, V1) entry matching with the multicast address G3, and may duplicate and send the packet of the multicast group G3 according to the membership information (VLAN1, spine1_P1) of outgoing interface information in the matching entry. The RB spine1 may send the data packet having the multicast address G3 and VLAN1 to the RB leaf1. The RB leaf1 may send the data packet having the multicast address G3 and VLAN1 to the RB leaf1. The RB leaf1 may receive the data packet having the multicast address G3 and VLAN1 at the port of leaf1_P1, find the (*, G3, V1) entry matching with (VLAN1, G3), and send the packet multicast data packet having the multicast address G2 and VLAN2 to client3 through the membership port leaf1_Pc in the outgoing interface of the matching (*, G3, V1) entry.

As may be seen from the descriptions of FIGS. 5, 6A, and 6B, a non-gateway RB in an access layer or aggregation layer in a data center may receive multicast data packets from a multicast source inside the data center and may send the multicast data packets in an original format, such as Ethernet format, to a gateway RB. The gateway RB may neither implement TRILL decapsulation before layer-3 routing, nor implement TRILL encapsulation when the gateway RB sends multicast data packets to receivers in other VLANs.

### Processing for Responding to an IGMP General Group Query Packet

An example of the present disclosure may illustrate the processing of an IGMP general group query packet. In the example, the RBs spine2 and spine4 each may periodically send an IGMP general group query packet respectively within VLAN1 and VLAN2. In order to reduce network bandwidth overhead in the TRILL domain, the RB spine2 and the RB spine4 each may select a TRILL VLAN pruned tree to send the IGMP general group query packet, so as to ensure that the RBs spine1 spine4 and the RBs leaf1˜leaf6 may respectively receive the IGMP general group query packet within VLAN1 and VLAN2.

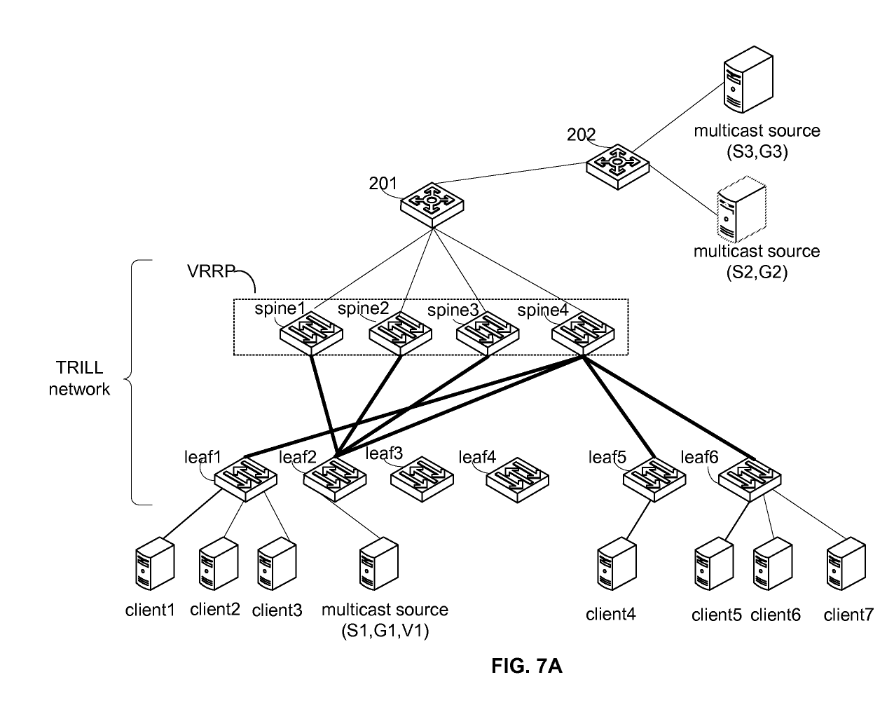

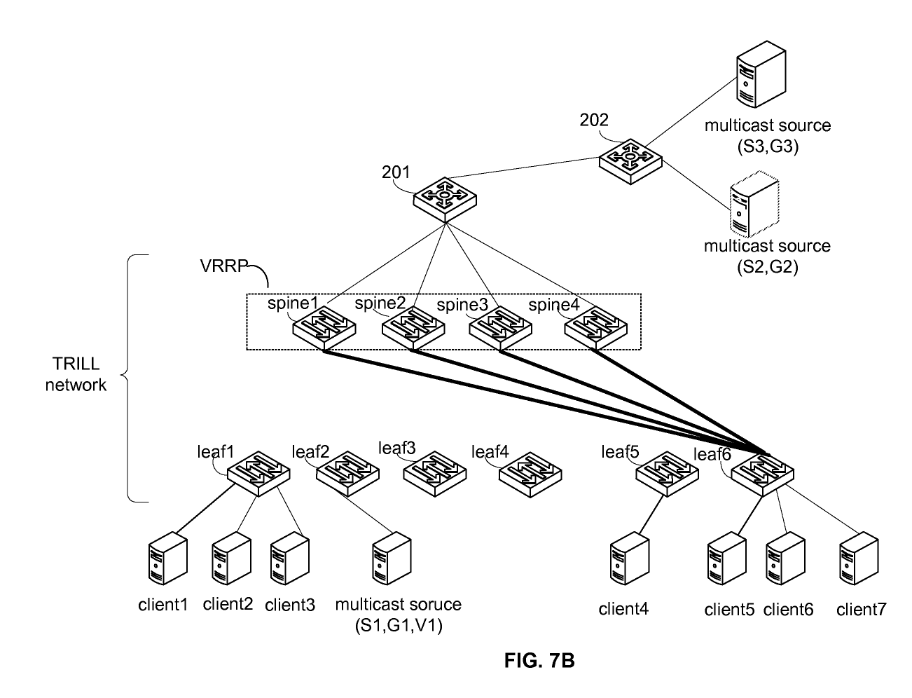

As shown in FIG. 7A, the TRILL VLAN pruned tree of VLAN1 may be rooted at the RB spine4, which is the querier RB of VLAN1. The RB spine4 may send a TRILL-encapsulated IGMP general group query packet to VLAN1, in which an ingress nickname may be a nickname of the RB spine4, and an egress nickname may be the nickname of the RB spine4, which is the root of the TRILL VLAN pruned tree of VLAN1.

As shown in FIG. 7B, the TRILL VLAN pruned tree of VLAN2 may be rooted at the RB spine2, which is the querier of VLAN2. The RB spine2 may send a TRILL-encapsulated IGMP general group query packet to VLAN2, in which an ingress nickname may be the nickname of the RB spine2, and an egress nickname may be the nickname of the RB spine2, which is the root of the TRILL VLAN pruned tree of VLAN2.

The RBs leaf1˜leaf6 each may receive the TRILL-encapsulated IGMP general group query packet within VLAN1 and VLAN2, and may respectively send the IGMP general group query packet through a local port of VLAN1 and a local port of VLAN2.

### Processing for an IGMP General Group Query Packet

In the example, the client2 may send, in response to receiving the IGMP general group query packet, an IGMP report packet joining the multicast G2. The RB leaf1 may receive, through the port leaf1_Pb, the IGMP report packet joining the multicast G2, reset the aging timer of membership port leaf1_Pb in the (*, G2, V1) entry, perform TRILL encapsulation to the IGMP report packet, and may send the TRILL-encapsulated IGMP report packet through leaf1_P1 which is the DR router port of VLAN1.

The RB spine1 may receive the TRILL-encapsulated IGMP report packet through the port spine1_P1, reset the aging timer of spine1_P1, which is the membership port of the membership information (VLAN1, spine1_P1) in the (*, G2, V1) entry. Manners in which other clients may process the IGMP general group query packet may be similar to what is described above.

### Processing for Leaving a Multicast Group

In an example, the client1 may leave the group G1. In the example, the client1, which belongs to VLAN1, may send an IGMP leave packet requesting to leave the multicast group G1.

The RB leaf1 may receive the IGMP leave packet through the membership port leaf1_Pa, perform TRILL encapsulation to the IGMP leave packet (in which a ingress nickname of a TRILL header may be the nickname of the RB leaf1, and a egress nickname of the TRILL header may be the nickname of the RB spine1, which is elected as the DR of VLAN1), and may forward the TRILL-encapsulated IGMP leave packet through leaf1_P1, which is the DR router port of VLAN1. The RB spine1 may receive the TRILL-encapsulated IGMP leave packet through port spine1_P1, and generate, based on the IGMP leave packet, an IGMP group specific query packet about the multicast group G1 and VLAN1. The RB spine1 may perform TRILL encapsulation to the IGMP group specific query packet, send the TRILL-encapsulated IGMP group specific query packet through spine1_P1, which is the port receiving the TRILL-encapsulated IGMP leave packet, and may reset the aging timer of spine1_P1, which is the membership port of the membership information (VLAN1, spine1_P1) in the (S1, G1, V1) entry.

The RB leaf1 may receive the TRILL-encapsulated IGMP group specific query packet, and analyze the IGMP group specific query packet to determine that the multicast group G1 in VLAN1 is to be queried. The RB leaf1 may send the IGMP group specific query packet through leaf1_Pa, which is the membership port of the (S1, G1, V1) entry. The RB leaf1 may reset a multicast group membership aging timer of leaf1_Pa.

The RB leaf1 may remove, in response to a determination that an IGMP report packet joining the group G1 is not received through the membership port leaf1_Pa within the configured time, the membership port leaf1_Pa from the (S1, G1, V1) entry, and may keep remaining router ports in the entry.

In response to a determination that the TRILL-encapsulated IGMP report packet joining the multicast G1 is not received at the membership port spine1_P1, which is the membership port in the member information (VLAN1, spine1_P1) in the (S1, G1, V1) entry and also the gateway router port of VLAN1, the RB spine1 may reset an aging timer of the membership port of VLAN1 included in the membership information (VLAN1, spine1_P1) in the (S1, G1, V1) entry. The RB spine1 may keep the membership information (VLAN1, spine1_P1) in the (S1, G1, V1) entry, and may keep the gateway router port of VLAN1 included in the (S1, G1, V1) entry. As such, a multicast data packet of a multicast source located inside the data center may be sent to other gateways of VLAN1, the data packet having the multicast address G1 and VLAN1 may be duplicated and forwarded, and the data packet of the multicast group G1 may be sent to receivers of other VLANs within the data center and receivers located outside the data center.

In an example of the present disclosure, the client3 may leave the multicast group G3. In the example, the RB leaf1 may receive an IGMP leave packet sent from the client3, perform the TRILL encapsulation to the IGMP leave packet (in which an ingress nickname of a TRILL header may be the nickname of the RB leaf1, and an egress nickname of the TRILL header may be the nickname of the RB spine1, which is elected as the DR of VLAN1, and may forward the TRILL-encapsulated IGMP leave packet through leaf1_P1, which is the DR router port of VLAN1.

The RB spine1 may receive the TRILL-encapsulated IGMP leave packet, decapsulate the TRILL-encapsulated IGMP leave packet to obtain the multicast group G3 requested to be left and VLAN1 to which the receiver belongs, and may send, through spine1_P1, which is a port receiving the TRILL-encapsulated IGMP leave packet, an IGMP group specific query packet about (G3, V1), in which the IGMP group specific query packet may be a multicast data packet, an ingress nickname of a TRILL header may be the nickname of the RB spine1, and an egress nickname of the TRILL header may be the nickname of the RB spine1, which is elected as the DR of VLAN1 and is the root of the multicast tree of VLAN1.

The RB leaf1 may receive the TRILL-encapsulated IGMP group specific query packet, decapsulate the IGMP group specific query packet to obtain the multicast group G3 to be queried and VLAN1 to which the multicast group G3 belongs, forward the IGMP group specific query packet through leaf1_Pc, which is the membership port of the local entry (*, G3, V1), and may reset the aging timer of leaf1_Pc. Subsequently, the RB leaf1 may remove the (*, G3, V1) entry in response to a determination that an IGMP report packet requesting to join the multicast group G3 is not received through the membership port leaf1_Pc within the configured time and an outgoing interface list of the (*, G3, V1) entry does not include other membership ports or the router ports including the DR router port or the gateway router port of VLAN1.

In response to the determination that the IGMP report packet requesting to join the multicast group G3 is not received within the configured period through spine1_P1, which is the membership port of the membership information (VLAN1, spine1_P1) in the (*, G3, V1) entry and the (*, G3, V1) entry does not include other membership information, the RB spine1 may remove the local (*, G3, V1) entry. The RB spine1, as the DR of VLAN1, may send to the RP router 202 a PIM prune packet about the multicast group G3 to remove a forwarding path from a multicast source of the multicast group G3 located outside the data center to the RB spine1.

A DR of each VLAN may not remove a local entry in response to a determination that the local entry may still include other membership information, and may not send a PIM prune packet to a RP located outside the data center.

Considering that a RB in the TRILL domain may be failed, examples of the present disclosure may also provide an abnormality processing mechanism to enhance the availability of the system.

In an example, when the RB spine1, as the DR of VLAN1, is failed, RBs spine2, spine3, and spine4 may re-elect the RB spine2 as the DR of VLAN1 (of course, it is possible to elect another gateway RB as a new DR of VLAN1). The RB spine2, spine3, and spine4 may re-advertise, through LSA of Layer 2 IS-IS protocol, the DR information, the gateway information, and the location information of the multicast source with the whole TRILL network. A nickname of the DR of VLAN1 included in the LSA sent by the RB spine2 may be the nickname of the RB spine2, which may indicate that the RB spine2 is the DR of VLAN1.

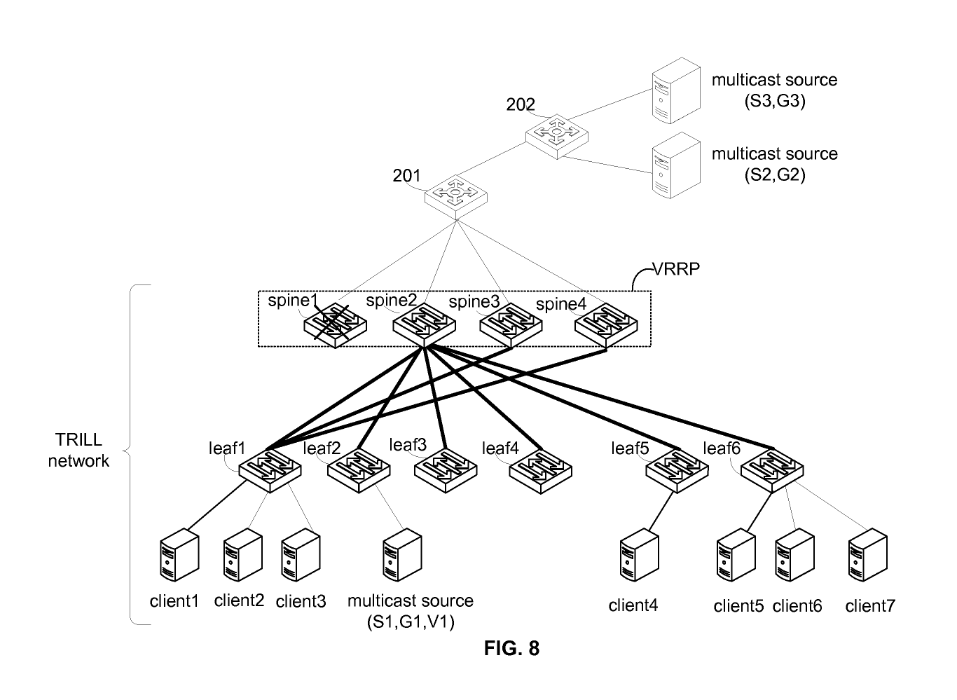

The RBs spine2˜spine4 and the RBs leaf1˜leaf6 may respectively update a local link state database according to the received LSA, and may calculate a TRILL multicast tree taking the RB spine2 which is the newly-elected DR as a root of the TRILL multicast tree, as shown in FIG. 8.

Based on the TRILL multicast tree as shown in FIG. 8, the RBs spine2˜spine4 and the RBs leaf1˜leaf6 may respectively recalculate a TRILL path towards the DR of VLAN1 and TRILL paths that are directed towards the three gateways of VLAN1, and may recalculate a DR router port of VLAN1 and a gateway router port of VLAN1 (specific calculation processes may refer to description of FIGS. 3A and 3B).

The RB spine2 may update the DR router port of VLAN1 with “null”, and may update the gateway router port of VLAN1 with the port “spine2_P1”. The RB spine3 may update the DR router port of VLAN1 with the port “spine3_P1”, and may update the gateway router port of VLAN1 with the port “spine3_P1”. The RB spine4 may update the DR router port of VLAN1 with the port “spine4_P1”, and may update the gateway router port of VLAN1 with the port “spine4_P1”.

The RB leaf1 may update the DR router port of VLAN1 with the port “leaf1_P2”, and may update the gateway router port of VLAN1 with the ports “leaf1_P2, leaf1_P3, and leaf1_P4”. The RB leaf2 may update the DR router port of VLAN1 with the port “leaf2_P2”, and may update the gateway router port of VLAN1 with the port “leaf2_P2”. The RB leaf3 may update the DR router port of VLAN1 with the port “leaf3_P2”, and may update the gateway router port of VLAN1 with the port “the RB leaf3_P2”. The RB leaf4 may update the DR router port of VLAN1 with the port “leaf4_P2”, and may update the gateway router port of VLAN1 with the port “leaf4_P2”. The RB leaf5 may update the DR router port of VLAN1 with the port “leaf5_P2”, and may update the gateway router port of VLAN1 with the port “the RB leaf5_P2”. The RB leaf6 may update the DR router port of VLAN1 with the port “leaf6_P2”, and may update the gateway router port of VLAN1 with the port “leaf6_P2”.

The RBs spine2˜spine4 may respectively update the gateway router port of VLAN1 in the membership information of the local (S1, G1, V1) entry. The RB spine2 may update the membership information (VLAN1, spine2_P1) of the local (S1, G1, V1) entry with (VLAN1, spine2_P1). The RB spine3 may update the membership information (VLAN1, spine3_P1) of the local (S1, G1, V1) entry with (VLAN1, spine3_P1). The RB spine4 may update the membership information (VLAN1, spine4_P1) of the local (S1, G1, V1) entry with (VLAN1, spine4_P1).

The RBs leaf1 and leaf2 may respectively update the DR router port and the gateway router port of VLAN1 in the membership information of the local (S1, G1, V1) entry. The RB leaf1 may update the DR router port and the gateway router port of VLAN1 in the local (S1, G1, V1) entry with the ports “leaf1_P2, leaf1_P3, and leaf1_P4”. The RB leaf2 may update the DR router port and the gateway router port of VLAN1 in the local (S1, G1, V1) entry with the port “leaf2_P2”.

The RB spine4, as the querier RB of VLAN1, may send the TRILL-encapsulated IGMP general group query packet to VLAN1. The RBs leaf1, leaf2, leaf5, and leaf6 may receive the TRILL-encapsulated IGMP general group query packet within VLAN1, and may respectively send the IGMP general group query packet through a local port of VLAN1.

The RB leaf1 may receive an IGMP report packet sent from client2, perform TRILL encapsulation to the IGMP report packet, and may send the TRILL-encapsulated IGMP report packet through leaf1_P2, which is the DR router port of VLAN1. The RB leaf5 may receive an IGMP report packet sent from client4, perform the TRILL encapsulation to the IGMP report packet, and may send the TRILL-encapsulated IGMP report packet through leaf5_P2, which is the DR router port of VLAN1. The RB leaf6 may receive IGMP report packets respectively sent from client5 and client6, perform the TRILL encapsulation to the received IGMP report packets, and may send the TRILL-encapsulated IGMP report packets through leaf6_P2, which is the DR router port of VLAN1.

The RB spine2 may receive the TRILL-encapsulated IGMP report packet, and add membership information (VLAN1, spine2_P5) to the outgoing interface in the local (S1, G1, V1) entry. The RB spine2 may configure a new local (*, G2, V1) entry, and may add membership information (VLAN1, spine2_P1) of an outgoing interface in the newly-configured entry. Since the RB spine2 has already updated the membership information (VLAN1, spine2_P1) in the local (S1, G1, V1) entry, the membership information may not be updated repeatedly. The RB spine2 may reset an aging timer for a membership port of existing membership information, and may configure an aging timer for a membership port of newly-added membership information. The client1 and client3 respectively leave the multicast groups G1 and G3, the DR of VLAN1 may configure a new entry based on the IGMP report packet joining the multicast group G2 which is sent from client2. As such, in one regard, router ports including a DR router port and a gateway router port and a membership port that are in an entry may be maintained and updated through an IGMP general group query packet periodically sent from an IGMP querier of a VLAN, and therefore the entry may be maintained according to changes of TRILL network topologies.

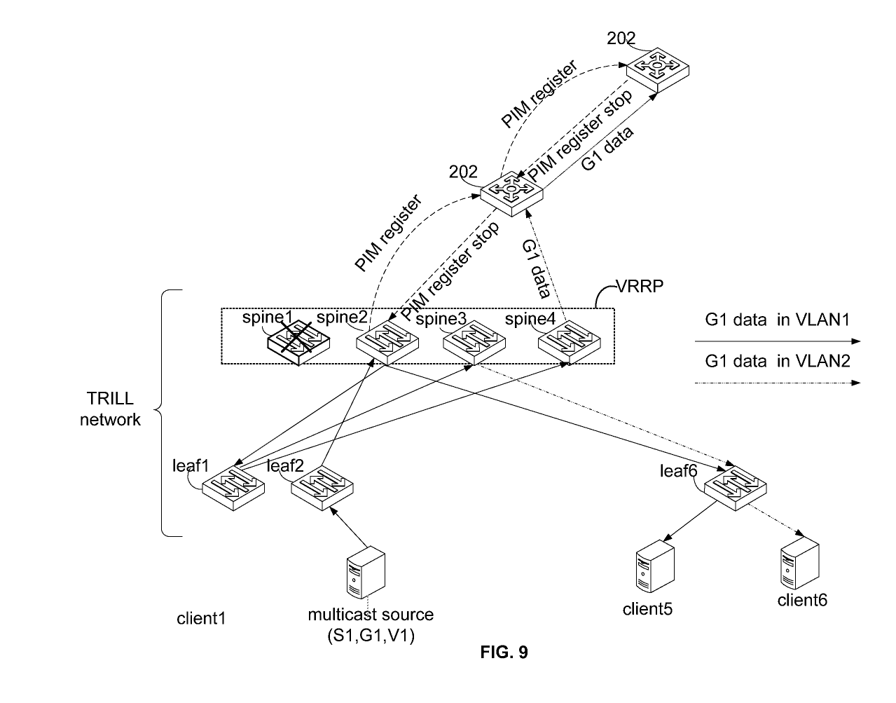

As shown in FIG. 9, in an example of the present disclosure, the multicast source (S1, G1, V1) of the multicast group G1 may send a multicast data packet to the RB leaf2. The RB leaf2 may send the multicast data packet to the RB spine2 through the port leaf2_P2, which is the DR router port of VLAN1 in the outgoing interface of the local (S1, G1, V1) entry.

The RB spine2 may receive the multicast data packet with the multicast address G1 of VLAN1, and may duplicate and send the packet of the multicast group G1 based on the membership information (VLAN1, spine1_P2) and (VLAN1, spine1_P6) in the local (S1, G1, V1) entry. As such, in one regard, the RB spine1 may send the packet with the multicast address G1 of VLAN1 to the RB leaf1 and leaf6. The RB spine2 may encapsulate the packet of the multicast group G1 as a PIM register packet, and may send the PIM register packet to the RP router 202.

The RB leaf6 may receive the data packet having the multicast address G1 and VLAN1, and may send the data packet having the multicast address G1 and VLAN1 through the port leaf6_Pa, which is the membership port in the local (*, G1, V1) entry. As such, the packet with the multicast address G1 of VLAN1 may be sent to the client5.

The RB leaf1 may receive the data packet having the multicast address G1 and VLAN1, and may send the data packet having the multicast address G1 and VLAN1 through the ports leaf1_P3 and leaf1_P4, which are the gateway router ports of VLAN1 in the local (S1, G1, V1) entry. As such, the data packet having the multicast address G1 and VLAN1 may be sent to the RBs spine3 and spine4.

The RB spine3 may receive the data packet having the multicast address G1 and VLAN1, and may duplicate and send the received data packet through the membership information (VLAN2, spine3_P6) in the local (S1, G1, V1) entry. As such, the RB spine3 may send the data packet having the multicast address G1 and VLAN2 to the RB leaf6. The RB leaf6 may receive the having the multicast address G1 and VLAN2, and may send the packet through membership port leaf6_Pb in the local (*, G1, V2) entry. As such, the data packet having the multicast address G1 and VLAN2 may be sent to the client6.

The RB spine4 may receive the data packet having the multicast address G1 and VLAN1, and may duplicate and send the packet through the membership information (VLAN100, spine4_Pout) in the local (S1, G1, V1) entry. As such, the packet with the multicast address G1 of VLAN100 may be sent to the outgoing router 201, and the outgoing router 201 may send the packet of the multicast group G1 towards the RP router 202.

The RP router 202 may receive the packet of the multicast group G1, and may send a PIM register-stop packet of the multicast group G1 to the RB spine2. The RB spine2 may receive the PIM register-stop packet, and may no longer send the PIM register packet to the RP router 202.

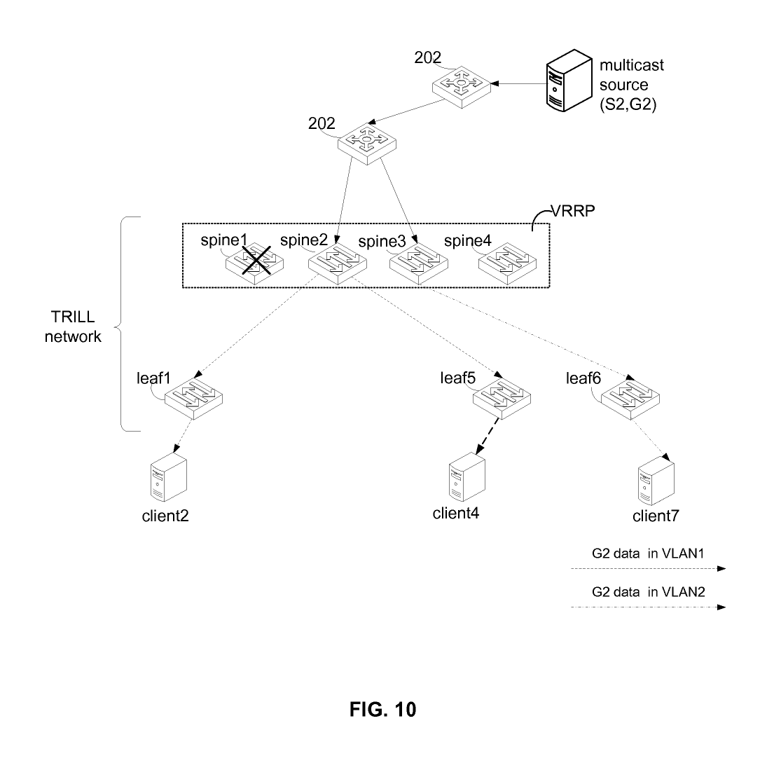

As shown in FIG. 10, the RP router 202 may receive a packet sent from a multicast source (S2, G2) located outside of the data center, and may send, based on a shared tree of the multicast group G2, the packet of the multicast group G2 to the RB spine2 (the DR of VLAN1) and spine3 (the DR of VLAN2).

The RB spine2 may receive the multicast data packet of the multicast group G2, find the (*, G2, V1) entry matching with the multicast address G2, and may duplicate and send the multicast data packet based on the membership information (VLAN1, spine2_P1) and (VLAN1, spine2_P5) in the matching entry. The RB spine2 may send the data packet having the multicast address G2 and VLAN1 to the RBs leaf1 and leaf5. After receiving the data packet having the multicast address G2 and VLAN1, the RB leaf1 may send the data packet through membership port leaf1_Pb in the local (*, G2, V1) entry. As such, the data packet having the multicast address G2 and VLAN1 may be sent to the client2. After receiving the data packet having the multicast address G2 and VLAN1, the RB leaf5 may send the data packet through leaf5_Pa, which is the membership port in the local (*, G2, V1) entry. As such, the data packet having the multicast address G2 and VLAN1 may be sent to the client4.

The RB spine3 may receive the multicast data packet of the multicast group G2, and may duplicate and send the packet based on the membership information (VLAN2, spine1_P6) in the local (*, G2, V1) entry. The RB spine3 may send the data packet having the multicast address G2 and VLAN2 to the RB leaf6. The RB leaf6 may send the data packet having the multicast address G2 and VLAN2 to the client7 through membership leaf6_Pc in the local (*, G2, V2) entry.

Since the client3 has left the multicast group G3 and the RB spine2, which is the newly-elected DR of VLAN1, may not send a PIM join packet requesting to join the multicast group G3, the RP router 202 may not send a packet of the multicast group G3 to the RB spine2.

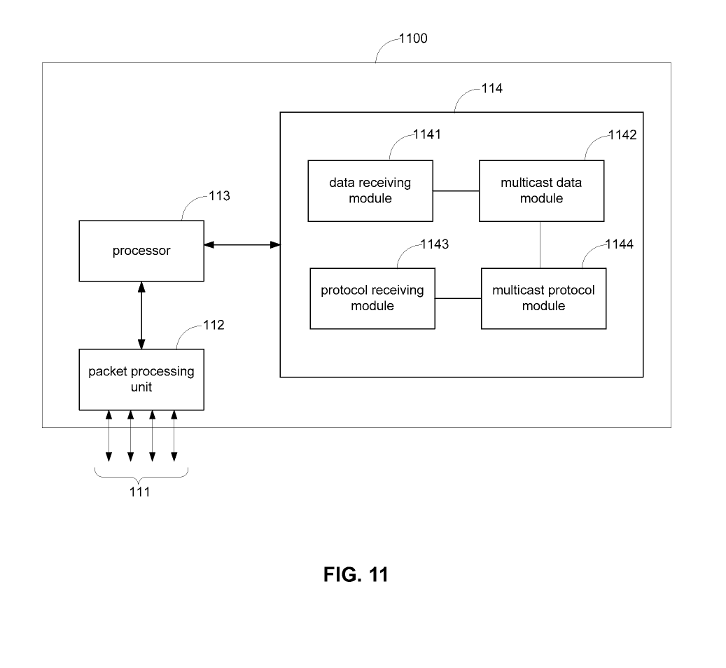

An example of the present disclosure also provides a network switch, as shown in FIG. 11. The network apparatus 1100 may include ports 111, a packet processing unit 112, a processor 113, and a storage 114. The packet processing unit 111 may transmit data packets and protocol packets received via the ports 111 to the processor 113 for processing, and may transmit data packets and protocol packets from the processor 113 to the ports 111 for forwarding. The storage 114 includes program modules to be executed by the processor 113, in which the program modules may include: a data receiving module 1141, a multicast data module 1142, a protocol receiving module 1143, and multicast protocol module 1144.

The data receiving module 1141 may receive a first multicast data packet having a first multicast address. The first multicast address may belong to a first multicast group having a multicast source inside of a data center. The multicast data module 1142 may send the first multicast packet through a designated router (DR) router port and a gateway router port, in which the DR router port and the gateway router port correspond to a virtual local area network identifier (VLAN ID) in the first multicast data packet.

The multicast data module 1142 may further send the first multicast packet through a membership port matching with the first multicast address and the VLAN ID in the first multicast data packet.

The protocol receiving module 1143 may receive an Internet Group Management Protocol (IGMP) report packet. The multicast protocol module 1144 may encapsulate the IGMP report packet into a transparent interconnection of lots of links (TRILL)-encapsulated IGMP report packet, store a receiving port of the IGMP report packet as a membership port matching with the multicast address and the VLAN ID in the first IGMP report packet, and send the TRILL-encapsulated IGMP report packet through a DR router port corresponding to the VLAN ID in the IGMP report packet, in which an ingress nickname and an egress nickname of the TRILL-encapsulated IGMP report packet are a local device identifier and a device identifier corresponding to a DR of a VLAN identified by the VLAN ID in the first IGMP packet.

The data receiving module 1141 may further receive a second multicast data packet having a second multicast address, in which the second multicast address belongs to a second multicast group having a multicast source outside of a data center. The multicast data module 1142 may further send the second multicast packet through a membership port matching with the second multicast address and a VLAN ID in the second multicast data packet.

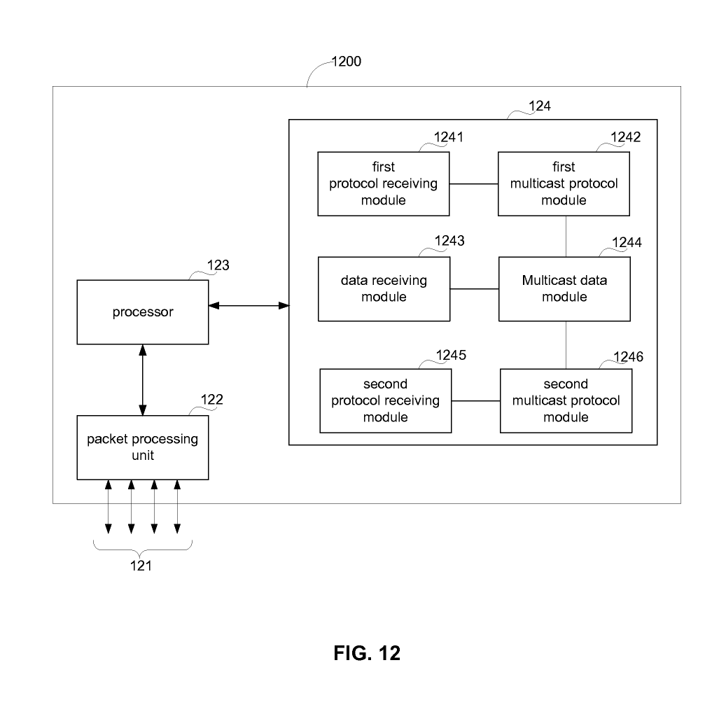

An example of the present disclosure also provides a network apparatus, such as a network switch, as shown in FIG. 12. The network apparatus 1200 may include ports 121, a packet processing unit 122, a processor 123, and a storage 124. The packet processing unit 122 may transmit packets including data packets and protocol packets received via the ports 121 to the processor 123 for processing and may transmit data packets and protocol packets from the processor 123 to the ports 121 for forwarding. The storage 124 may include program modules to be executed by the processor 123, in which the program modules may include: a first protocol receiving module 1241, a first multicast protocol module 1242, a data receiving module 1243, a multicast data module 1244, a second protocol receiving module 1245, and a second multicast protocol module 1246.

The first protocol receiving module 1241 may receive a first TRILL-encapsulated IGMP report packet in which a first IGMP report packet has a first multicast address, in which the first multicast address belongs to a first multicast group having a multicast source outside of a data center. The first protocol module 1242 may store a first membership information matching with the first multicast address, in which the first membership information including a receiving port of the first TRILL-encapsulated IGMP report packet and the VLAN ID in the first IGMP report packet. The data receiving module 1243 may receive a first multicast data packet having the first multicast address. The multicast data module may implement layer-3 routing based on the first membership information.

The second protocol receiving module 1245 may receive a protocol independent multicast (PIM) join packet having a second multicast address, in which the second multicast address belongs to a second multicast group having a multicast source inside of the data center. The second multicast protocol module 1246 may store a second membership information matching with the second multicast address, in which the second membership information includes a receiving port and a VLAN ID of the PIM join packet. The data receiving module 1243 may further receive a second multicast data packet having the second multicast address. The multicast data module 1244 may implement layer-3 routing based on the second membership information.

The first protocol receiving module 1241 may further receive a second TRILL-encapsulated IGMP report packet in which a second IGMP report packet has the second multicast address. The first multicast protocol module 1242 may further store a third membership matching with the second multicast address, in which the third membership includes a receiving port of the second TRILL-encapsulated IGMP report packet and a VLAN ID in the second IGMP report packet. The data receiving module 1243 may further receive the second multicast data packet. The multicast data module 1244 may implement layer-3 routing based on the third membership information.

The second multicast protocol module 1246 may encapsulate the second multicast data packet into a PIM register packet, and may send the PIM register packet.

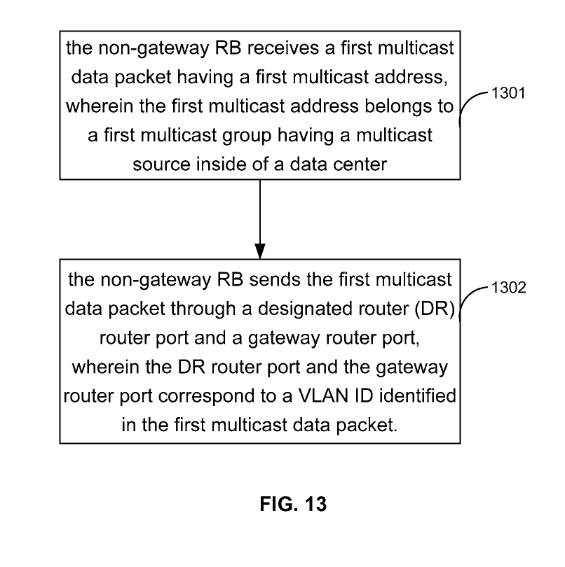

FIG. 13 is a flowchart illustrating a method for forwarding multicast data packets using a non-gateway RB in accordance with an example of the present disclosure. As shown in FIG. 13, the method may include the following blocks.

In block 1301, the non-gateway RB receives a first multicast data packet having a first multicast address, wherein the first multicast address belongs to a first multicast group having a multicast source inside of a data center.

In block 1302, the non-gateway RB sends the first multicast data packet through a designated router (DR) router port and a gateway router port, wherein the DR router port and the gateway router port correspond to a virtual local area network identifier (VLAN ID) identified in the first multicast data packet.

With the above method, a non-gateway RB, such as a RB in an access layer or an aggregation layer of a data center, may send multicast data packets, which are from a multicast source inside the data center, to a gateway RB in the data center without TRILL encapsulation.

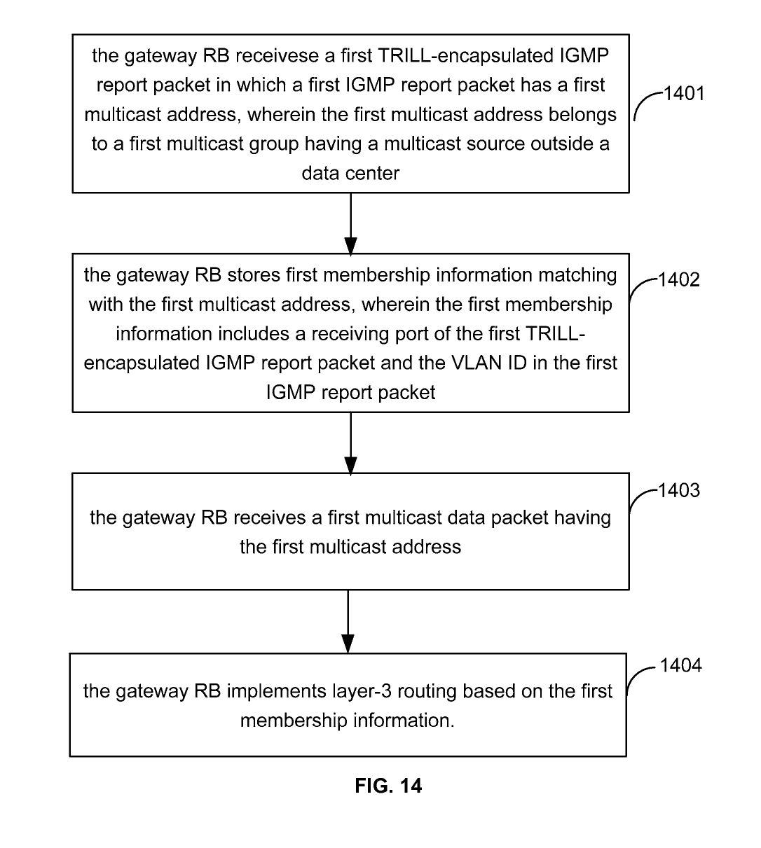

FIG. 14 is a flowchart illustrating a method for forwarding multicast data packets using a gateway RB in accordance with an example of the present disclosure. As shown in FIG. 14, the method may include the following blocks.

In block 1401, the gateway RB receives a first TRILL-encapsulated IGMP report packet in which a first IGMP report packet has a first multicast address, wherein the first multicast address belongs to a first multicast group having a multicast source outside a data center.

In block 1402, the gateway RB stores first membership information matching with the first multicast address, wherein the first membership information includes a receiving port of the first TRILL-encapsulated IGMP report packet and the VLAN ID in the first IGMP report packet.

In block 1403, the gateway RB receives a first multicast data packet having the first multicast address.

In block 1404, the gateway RB implements layer-3 routing based on the first membership information.

With the above method, a gateway RB, such as a RB in a core layer in a data center, may receive multicast data packets from a multicast source inside a data center and implement layer-3 routing without TRILL encapsulation.

It should be noted that a structure of a TRILL multicast tree may vary with different algorithms. Regardless of how the structure of the TRILL multicast tree is changed, in the TRILL multicast tree of which a root is the DR disclosed herein, the manners for calculating a DR router port and a gateway router port may be unchanged, and the manners for forwarding a TRILL-format multicast data packet and forwarding an initial-format packet disclosed herein may be unchanged.

It should be noted that examples of the present disclosure described above may be illustrated taking the IGMP protocol, the IGSP protocol, and the PIM protocol as an example. The above protocols may also be replaced with other similar protocols, under this circumstance, the multicast forwarding solution provided by the examples of the present disclosure may still be achieved, and the same or similar technical effects may still be achieved, as well.

The above examples of the present disclosure may be illustrated taking the TRILL technology within a data center as an example, relevant principles may also be applied to other VLL2 networking technologies, such as virtual extended virtual local area network (Vxlan) protocol (a draft of the IETF), the SPB protocol, and so forth.

In the above examples, at a control plane, a device within a VLL2 network of a data center may forward a multicast data packet based on an acyclic topology generated by a VLL2 network control protocol (such as TRILL), as such, the VLL2 protocol encapsulation may be performed to the multicast data packet within the data center. At a data forwarding plane, the device within the VLL2 network of the data center may forward a multicast data packet based on an entry maintained by the topology of the VLL2 network, as such, the VLL2 protocol encapsulation may not be performed to the multicast data packet within the data center.

The above examples may be implemented by hardware, software or firmware, or a combination thereof. For example, the various methods, processes and functional modules described herein may be implemented by a processor (the term processor is to be interpreted broadly to include a CPU, processing unit, ASIC, logic unit, or programmable gate array, etc.). The processes, methods, and functional modules disclosed herein may all be performed by a single processor or split between several processors. In addition, reference in this disclosure or the claims to a ‘processor’ should thus be interpreted to mean ‘one or more processors’. The processes, methods and functional modules disclosed herein may be implemented as machine readable instructions executable by one or more processors, hardware logic circuitry of the one or more processors or a combination thereof. Further the examples disclosed herein may be implemented in the form of a computer software product. The computer software product may be stored in a non-transitory storage medium and may include a plurality of instructions for making a computer apparatus (which may be a personal computer, a server or a network apparatus such as a router, switch, access point, etc.) implement the method recited in the examples of the present disclosure.

All or part of the procedures of the methods of the above examples may be implemented by hardware modules following machine readable instructions. The machine readable instructions may be stored in a computer readable storage medium. When running, the machine readable instructions may provide the procedures of the method examples. The storage medium may be diskette, CD, ROM (Read-Only Memory) or RAM (Random Access Memory), and etc.

The figures are only illustrations of examples, in which the modules or procedures shown in the figures may not be necessarily essential for implementing the present disclosure. The modules in the aforesaid examples may be combined into one module or further divided into a plurality of sub-modules.

The above are several examples of the present disclosure, and are not used for limiting the protection scope of the present disclosure. Any modifications, equivalents, improvements, etc., made under the principle of the present disclosure should be included in the protection scope of the present disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

1. A method for forwarding multicast data packets, the method comprising,
receiving a first multicast data packet having a first multicast address, wherein the first multicast address belongs to a first multicast group having a multicast source inside of a data center; and
sending the first multicast data packet through a designated router (DR) router port and a gateway router port, wherein the DR router port and the gateway router port correspond to a virtual local area network identifier (VLAN ID) identified in the first multicast data packet.

2. The method of claim 1, further comprising:
sending the first multicast packet through a membership port matching with the first multicast address and the VLAN ID identified in the first multicast data packet.

3. The method of claim 1, further comprising:
receiving an Internet Group Management Protocol (IGMP) report packet;
encapsulating the IGMP report packet into a transparent interconnection of lots of links (TRILL)-encapsulated IGMP report packet, wherein an ingress nickname and an egress nickname of the TRILL-encapsulated IGMP report packet are a local device identifier and a device identifier corresponding to a DR of a VLAN identified by the VLAN ID in the first IGMP packet;
storing a receiving port of the IGMP report packet as a membership port matching with the multicast address and the VLAN ID in the first IGMP report packet; and
sending the TRILL-encapsulated IGMP report packet through a DR router port corresponding to the VLAN ID in the IGMP report packet.

4. The method of claim 1, further comprising:
receiving a second multicast data packet having a second multicast address, wherein the second multicast address belongs to a second multicast group having a multicast source outside of a data center; and
sending the second multicast data packet through a membership port matching with the second multicast address and a VLAN ID in the second multicast data packet.

5. A network apparatus for forwarding multicast packets, the network apparatus comprising:
a data receiving module and a multicast data module, wherein,
the data receiving module is to receive a first multicast data packet having a first multicast address, wherein the first multicast address belongs to a first multicast group having a multicast source inside of a data center; and
the multicast data module is to send the first multicast packet through a designated router (DR) router port and a gateway router port, wherein the DR router port and the gateway router port correspond to a virtual local area network identifier (VLAN ID) in the first multicast data packet.

6. The network apparatus of claim 5, wherein,
the multicast data module is further to send the first multicast packet through a membership port matching with the first multicast address and the VLAN ID in the first multicast data packet.

7. The network apparatus of claim 5, further comprising:
a protocol receiving module and a multicast protocol module, wherein, the protocol receiving module is to receive an Internet Group Management Protocol (IGMP) report packet;
the multicast protocol module is to encapsulate the IGMP report packet into a transparent interconnection of lots of links (TRILL)-encapsulated IGMP report packet, store a receiving port of the IGMP report packet as a membership port matching with the multicast address and the VLAN ID in the first IGMP report packet; and send the TRILL-encapsulated IGMP report packet through a DR router port corresponding to the VLAN ID in the IGMP report packet; and
wherein an ingress nickname and an egress nickname of the TRILL-encapsulated IGMP report packet are a local device identifier and a device identifier corresponding to a DR of a VLAN identified by the VLAN ID in the first IGMP packet.

8. The network apparatus of claim 5, wherein,
the data receiving module is further to receive a second multicast data packet having a second multicast address, wherein the second multicast address belongs to a second multicast group having a multicast source outside a data center; and
the multicast data module is further to send the second multicast packet through a membership port matching with the second multicast address and a VLAN ID in the second multicast data packet.

9. A method for forwarding multicast data packets, the method comprising,
receiving a first transparent interconnection of lots of links (TRILL)-encapsulated Internet Group Management Protocol (IGMP) report packet in which a first IGMP report packet has a first multicast address, wherein the first multicast address belongs to a first multicast group having a multicast source outside a data center;
storing first membership information matching with the first multicast address, wherein the first membership information includes a receiving port of the first TRILL-encapsulated IGMP report packet and a virtual local area network identifier (VLAN ID) in the first IGMP report packet;
receiving a first multicast data packet having the first multicast address; and
implementing layer-3 routing based on the first membership information.

10. The method of claim 9, further comprising:
receiving a protocol independent multicast (PIM) join packet having a second multicast address, wherein the second multicast address belongs to a second multicast group having a multicast source inside a data center;
storing second membership information matching with the second multicast address, wherein the second membership information includes a receiving port and a VLAN ID of the PIM join packet;
receiving a second multicast data packet having the second multicast address; and
implementing layer-3 routing based on the second membership information.

11. The method of claim 9, further comprising:
receiving a second TRILL-encapsulated IGMP report packet in which a second IGMP report packet has a second multicast address;
storing third membership information matching with the second multicast address, wherein the third membership information includes a receiving port of the second TRILL-encapsulated IGMP report packet and a VLAN ID in the second IGMP report packet;
receiving the second multicast data packet; and
implementing layer-3 routing based on the third membership information.

12. The method of claim 9, further comprising:
encapsulating the second multicast data packet into a PIM register packet based on a rendezvous point (RP) router of the second multicast group; and
sending the PIM register packet to the RP router of the second multicast group.

13. A network apparatus for forwarding multicast packets, the network apparatus comprising:
a first protocol receiving module, a first protocol module, a data receiving module and a multicast data module, wherein,
the first protocol receiving module is to receive a first transparent interconnection of lots of links (TRILL)-encapsulated Internet Group Management Protocol (IGMP) report packet in which a first IGMP report packet has a first multicast address, wherein the first multicast address belongs to a first multicast group having a multicast source outside of a data center;
the first protocol module is to store first membership information matching with the first multicast address, wherein the first membership information includes a receiving port of the first TRILL-encapsulated IGMP report packet and a virtual local area network identifier (VLAN ID) in the first IGMP report packet;
the data receiving module is to receive a first multicast data packet having the first multicast address; and
the multicast data module is to implement layer-3 routing based on the first membership information.

14. The network apparatus of claim 13, further comprising:
a second protocol receiving module and a second multicast protocol module, wherein,
the second protocol receiving module is to receive a protocol independent multicast (PIM) join packet having a second multicast address, wherein the second multicast address belongs to a second multicast group having a multicast source inside the data center;
the second multicast protocol is to store second membership information matching with the second multicast address, wherein the second membership information includes a receiving port and a VLAN ID of the PIM join packet;
the data receiving module is to receiving a second multicast data packet having the second multicast address; and
the multicast data module is to implement layer-3 routing based on the second membership information.

15. The network apparatus of claim 13, wherein,
the first protocol receiving module is to receive a second TRILL-encapsulated IGMP report packet in which a second IGMP report packet has a second multicast address;
the first protocol module is to store third membership information matching with the second multicast address, wherein the third membership information includes a receiving port of the second TRILL-encapsulated IGMP report packet and a VLAN ID in the second IGMP report packet;
the data receiving module is to receive the second multicast data packet; and
the multicast data module is to implement layer-3 routing based on the third membership information.

16. The network apparatus of claim 13, wherein,
the second multicast protocol module is to encapsulate the second multicast data packet into a PIM register packet, and send the PIM register packet.
